(19) United States
(12) Patent Application Publication
(10) Pub. No.: US 2009/0029179 A1
(43) Pub. Date: Jan. 29, 2009

(54) TWO-LIQUID COMPOSITION, HYDROPHILIC COMPOSITION AND HYDROPHILIC MEMBER

(75) Inventors: Makoto FUKUDA, Kanagawa (JP); Satoshi HOSHI, Tokyo (JP); Yoshiaki KONDO, Odawara-shi (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/119,901

(22) Filed: May 13, 2008

(30) Foreign Application Priority Data
May 14, 2007 (JP) 2007-128584
Mar. 25, 2008 (JP) 2008-079326

(51) Int. Cl. B32B 15/04; C08L 83/04

(52) U.S. Cl. 428/447; 525/477; 525/475; 525/342; 525/370; 525/191; 525/218; 525/217; 525/212

(57) ABSTRACT

A two-liquid composition, includes (A) a first liquid composition that contains a hydrophilic polymer having a hydrolyzable silyl group; and (B) a second liquid composition that contains a catalyst capable of accelerating reaction of the hydrolyzable silyl group, and a hydrophilic member is formed by mixing the first liquid composition (A) and the second liquid composition (B), coating a substrate with the resultant mixture and drying the mixture coated.

### BACKGROUND OF THE INVENTION

1. Field of the Invention

The present invention relates to a two-liquid composition and a hydrophilic composition, and further to a hydrophilic member, a fin material, an aluminum fin material, a heat exchanger and an air conditioner which each have a hydrophilic film formed by using either of those compositions.

2. Description of the Related Art

Products and members having resin film surfaces are used in a wide variety of fields. In advance of their uses, they are subjected to processing suitable for their individual purposes, and thereby the desired functions are imparted to them. However, their surfaces generally show hydrophobicity and lipophilicity in view of properties intrinsic in resins. Therefore, there were cases where, when oils or like contaminants adhered to those surfaces, they were not easy to eliminate, and besides, accumulation thereof seriously degraded functions and properties of products and members having resin film surfaces. Moreover, when products and members having transparent appearances were exposed to much moisture or rainfall, there occurred a problem that adhesion of waterdrops to their surfaces caused diffuse reflections of light to result in impairment of their transmittancy. Even in the cases of products and members having inorganic surfaces, such as glass and metal surfaces, it cannot be said that they were able to fully avoid fouling by adhesion of contaminants like oils. In addition, they were insufficient in the property of preventing their surface fogging by adhesion of waterdrops. Glass used for cars and building materials in particular frequently encounters such cases that the visibility through the glass (the visibility by reflection from the glass in the mirror's case) becomes difficult to secure when the glass suffers adhesion of hydrophobic contaminants including smoke and dust in urban areas, combustion products contained in car exhaust fumes, such as carbon black, oils and fats, and elution components of sealants, or adhesion of waterdrops. So, it has been strongly desired to impart antifouling and antifogging capabilities to glass.

From the antifouling point of view, under the assumption that contaminants are organic substances like oils, foul prevention requires for the material surface to have a reduced interaction with the contaminants, namely to be rendered hydrophilic or lipophobic. With respect to the antifogging property, on the other hand, it becomes necessary to impart the material surface a spreading wettability (or hydrophilicity) for uniform spread of attached waterdrops, or to impart water repellency to the material surface for easy removal of attached waterdrops. Accordingly, many of antifouling and antifogging materials under study are based on impartment of hydrophilic or water-repellent and lipophobic properties.

According to surface treatment methods hitherto proposed for the purpose of imparting hydrophilicity to a material surface, such as etching treatment and plasma treatment, high degree of hydrophilicity can be imparted to the material surface, but its effect is transitory and it is impossible to maintain the hydrophilic state for a long time. In addition, the coating film using a hydrophilic graft polymer as an example of hydrophilic resin and thereby having surface hydrophilicity is proposed (Kagaku Kougyou Nippou (The Chemical Daily), Jan. 30, 1995). According to this report, the coating film has a measure of hydrophilicity, but it cannot be said that the coating film has sufficient affinity for a substrate. Therefore, higher durability is required of the coating film.

As to other members having water-attracting functions at the surface, utilization of titanium oxide as a photo-catalyst for members has so far been known. This utilization is based on capabilities of organic materials to decompose by oxidation and become hydrophile under irradiation with light. For instance, WO 96/029375 pamphlet discloses that formation of a layer containing a photo-catalyst on the substrate surface makes the surface highly hydrophilic in response to photo excitation of the photo-catalyst. And therein it is reported that application of such an art to various composite materials including glass, lenses, mirrors, exterior materials and members for water using places in buildings makes it possible to impart excellent functions, such as antifogging and antifouling functions, to the composite materials. Although members having glass surfaces coated with titanium oxide are used as self-cleaning materials for building windowpanes and car windshields, longtime exposure to sunbeams is necessary to development of their antifouling and antifogging functions, so it is inevitable that their properties are degraded by contaminants accumulated during the passage of a long time. In addition, it cannot be said that the coating film has sufficient strength, so durability improvement is required of the coating film. Likewise, self-cleaning film having a titanium oxide layer on a plastic substrate is also used for car side-view mirrors, but the strength thereof is insufficient. So, hydrophilic materials having greater resistance to abrasion are demanded.

On the one hand, silicone compounds and fluorine compounds are mainly used as materials that can avoid fouling and fogging on the basis of water-repellent and lipophobic properties. For example, the antifouling material whose substrate surface is coated with terminal-silanol organopolysiloxane is disclosed in JP-A-4-338901, the material containing a silane compound with a polyfluoroalkyl group is disclosed in JP-B-6-29332, and the combination of an optical thin film predominantly composed of silicon dioxide with a copolymer of perfluoroacrylate and a monomer having an alkoxysilane group is disclosed in JP-A-7-16940. However, the antifouling materials using such silicone and fluorine compounds are insufficient in an antifouling function, so it is difficult to clean contaminants, such as fingerprints, sebum, sweat and cosmetics, off those materials, and besides, there is apprehension that the surface treatment with compounds of low surface energy, such as fluorine and silicone compounds, causes deterioration in functions with a lapse of time. With this being the situation, it is desirable to develop antifouling and antifogging materials with greater durability.

On the other hand, there are many cases where polymers having hydrolyzable silyl groups are mixed with a catalyst, a metal alkoxide, a plasticizer, a filler and so on, and then used as curable compositions. However, curable compositions currently in use have a problem that aggregates appear therein and their viscosity is increased with a lapse of time.

### SUMMARY OF THE INVENTION

An object of the invention is to provide a two-liquid composition having high temporal stability as a curable composition in which a hydrophilic polymer having a hydrolyzable silyl group is contained.

Another object of the invention is to provide a hydrophilic member that can impart outstanding hydrophilicity to the surface of various kinds of articles, and besides, that has excellent scratch resistance, storage stability and surface conditions.

The above objects were solved by the following measures.

[1] A two-liquid composition, comprising:

(A) a first liquid composition that contains a hydrophilic polymer having a hydrolyzable silyl group; and

(B) a second liquid composition that contains a catalyst capable of accelerating reaction of the hydrolyzable silyl group,

[2] The two-liquid composition as described in [1] above,

wherein the first liquid composition (A) further contains a metal alkoxide compound.

[3] The two-liquid composition as described in [2] above,

wherein the metal alkoxide compound is a compound represented by formula (VI):

(R¹³)ₖ-Q-(OR¹⁴)₄₋ₖ (VI)

wherein R¹³ represents a hydrogen atom, an alkyl group or an aryl group;

R¹⁴ represents an alkyl group or an aryl group;

Q represents Si, Al, Ti or Zr; and

k represents an integer of 0 to 2.

[4] The two-liquid composition as described in any of [1] to [3] above,

wherein the catalyst contains an acid and a metal chelate or a metal salt.

[5] The two-liquid composition as described in [4] above,

wherein a metal contained in the metal chelate or the metal salt is at least one kind selected from the group consisting of Ti, Zr and Al.

[6] The two-liquid composition as described in [4] or [5] above,

wherein the acid is hydrochloric acid or nitric acid, and

the metal chelate or the metal salt is selected from the group consisting of aluminum ethylacetoacetate diisopropylate, aluminum tris(ethylacetoacetate), di(acetylacetonato)titanium complex salt, zirconium tris(ethylacetoacetate), ZrOCl₂.8H₂O, ZrO(NO₃)₂.4H₂O and AlCl₃.

[7] The two-liquid composition as described in any of [1] to [6] above,

wherein the hydrophilic polymer having a hydrolyzable silyl group is a polymer having at least one kind of structures represented by formulae (I) to (III):

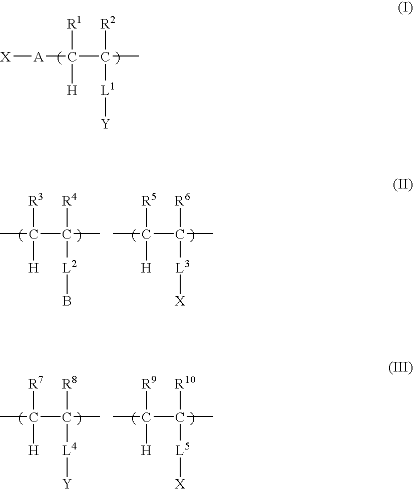

wherein R¹, R², R³, R⁴, R⁵, R⁶, R⁷, R⁸, R⁹ and R¹⁰ each represents a hydrogen atom or a hydrocarbon group independently;

X represents a hydrolyzable silyl group;

A, L¹, L², L³, L⁴ and L⁵ each represents a single bond or a linkage group independently;

Y represents —NHCOR¹¹, —CONH₂, —CON(R¹¹)₂, —COR¹¹, —OH, —CO₂M, —SO₃M, —PO₃M, —OPO₃M or —N(R¹¹)₃Z¹, wherein R¹¹ represents an alkyl group, an aryl group or an aralkyl group; M represents a hydrogen atom, an alkali metal, an alkaline earth metal or an onium; and Z¹ represents a halogen ion; and

B represents a group having a structure represented by formula (IV):

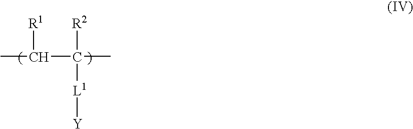

wherein R¹, R², L¹ and Y have the same meanings as in formula (I), respectively.

[8] The two-liquid composition as described in [7] above,

wherein the L⁵ in formula (III) represents a single bond or a linkage group having at least one structure selected from the group consisting of —CONH—, —NHCONH—, —OCONH—, —SO₂NH— and —SO₃—.

[9] The two-liquid composition as described in any of [1] to [8] above, which comprises the catalyst in the second liquid composition (B) in a proportion of 0.1 to 15 parts by mass with respect to 100 parts by mass of the hydrophilic polymer contained in the first liquid composition (A).

[10] The two-liquid composition as described in any of [1] to [9] above,

wherein the first liquid composition (A) has a viscosity of 100 mPa·s or below at 20° C.

[11] A hydrophilic composition, obtained by adding the second liquid composition (B) as described in any of [1] to [10] above into the first liquid composition (A) as described in any of [1] to [10] above under stirring at a revolution speed of 100 rpm or above.

[12] The two-liquid composition as described in any of [7] to [10] above or the hydrophilic composition as described in [11] above,

wherein the hydrophilic polymer having a hydrolyzable silyl group includes:

(I) a hydrophilic polymer having the structure represented by the formula (I); and

(II) a hydrophilic polymer having the structure represented by the formula (II) or (III) a hydrophilic polymer having the structure represented by the formula (III), and

a mass ratio of the hydrophilic polymer (I)/the hydrophilic polymer (II) or the hydrophilic polymer (I)/the hydrophilic polymer (III) ranges from 50/50 to 5/95.

[13] A hydrophilic member, comprising:

a hydrophilic film formed by coating a substrate with the two-liquid composition as described in any of [1] to [10] and [12] above or the hydrophilic composition as described in [11] above and then drying the composition.

[14] A fin material, comprising:

a hydrophilic film formed by applying the two-liquid composition as described in any of [1] to [10] and [12] above or the hydrophilic composition as described in [11] above and then drying the composition.

[15] An aluminum fin material, comprising:

the fin material as described in [14] above, the fin material being made from aluminum.

[16] A heat exchanger, comprising:

the aluminum fin material as described in [15] above.

[17] An air conditioner, comprising:

the heat exchanger as described in [16] above.

### DETAILED DESCRIPTION OF THE INVENTION

The invention is described in detail below.

An aspect of the invention is a two-liquid composition including (A) a first liquid composition that contains a hydrophilic polymer having a hydrolyzable silyl group and (B) a second liquid composition that contains a catalyst capable of accelerating reaction of the hydrolyzable silyl group.

The term “a two-liquid composition” used in the invention refers to a composition obtained by mixing the first liquid composition (A) and the second liquid composition (B) on the point of or just before its use.

In the present two-liquid composition, a hydrophilic polymer having a hydrolyzable silyl group and a catalyst are not present together until the instant preceding the use of the composition, so the hydrophilic polymer and the metal alkoxide are hard to cure, and the composition can be restrained from forming aggregates and increasing its viscosity during the time elapsed between preparation and use of the composition. Thus, it becomes possible to obtain hydrophilic film having high film strength and excellent surface conditions when formed by coating.

The first liquid composition (A) and the second liquid composition (B) are preferably mixed together at the time of use. The time between the mixing and the use can be chosen appropriately with consideration given to concentrations and kinds of the hydrophilic polymer and the catalyst incorporated, the intended end-usage of the two-liquid composition prepared, and so on. Specifically, it is preferable that the present composition is used within 24 hours of the mixing, especially within 6 hours of the mixing.

Because the mixing is carried out at the time of use, it becomes possible to adopt a catalyst having high acceleration effect on reaction of hydrolyzable silyl groups to result in formation of high-strength hydrophilic film.

Ingredients of the present two-liquid composition are illustrated below.

### First Liquid Composition (A)

### (Hydrophilic Polymer Having Hydrolyzable Silyl Group)

The first liquid composition (A) in the invention contains a hydrophilic polymer having a hydrolyzable silyl group. Because the hydrophilic polymer used in the invention has a hydrolyzable silyl group, the silanol group as a hydrolysis product of the hydrolyzable silyl group forms Si—O—Si linkage by undergoing condensation reaction. As a result, it becomes possible to form strong film.

Herein, the term “hydrolyzable silyl group” refers to the group containing a silicon atom to which a hydrolyzable group, is attached. Examples of such a hydrolyzable group include a hydrogen atom, a halogen atom, an alkoxyl group, an acyloxide group, a ketoximate group, an amino group and an amido group.

In the invention, it is preferable that the hydrolyzable silyl group is a hydrolyzable silyl group represented by the following formula (V).

—SiR¹²₃₋ₘ(OR¹³)ₘ (V)

In the formula (V), R¹² and R¹³ each represents a hydrogen atom or a hydrocarbon group having 1 to 8 carbon atoms independently, and m represents an integer of 1 to 3. In such a silyl group, R¹² is preferably a hydrocarbon group having 1 to 3 carbon atoms and R¹³ is preferably a hydrogen atom or a hydrocarbon group having 1 to 3 carbon atoms.

And the hydrophilic polymer used in the invention has a hydrophilic group. Suitable examples of such a hydrophilic group are functional groups including a carboxyl group, an alkali metal salt of carboxyl group, a sulfonic acid group, an alkali metal salt of sulfonic acid group, a hydroxyl group, an amido group, a carbamoyl group, a sulfonamido group and a sulfamoyl group. These groups may be present at any site in the polymer. In other words, they may bind to the polymer's main chain directly or via linkage groups, or may form bonding in the polymer's side chains or grafted side chains. And it is preferable that the polymer has a structure in which two or more hydrophilic groups are present.

Additionally, it is preferable that the polymer used in the invention is a polymer having groups capable of forming combinations with a metal alkoxide as described below by the action of a catalyst or the like. Besides including hydrolyzable silyl groups represented by formula (V), examples of groups capable of forming combinations with a metal alkoxide by the action of a catalyst include reactive groups such as a carboxyl group, an alkali metal salt of carboxyl group, a carboxylic anhydride group, an amino group, a hydroxyl group, an epoxy group, a methylol group, a mercapto group, an isocyanate group, a blocked isocyanate group, an alkoxysilyl group, an alkoxytitanate group, an alkoxyaluminate group, an alkoxyzirconate group, an ethylenic unsaturated group, an ester group and a tetrazolyl group. Suitable examples of a polymer structure having hydrophilic groups and groups capable of forming combinations with a metal alkoxide by the action of a catalyst or the like include polymer structures formed by vinyl polymerization of ethylenic unsaturated groups (e.g., an acrylate group, a methacrylate group, an itaconic acid group, a crotonic acid group, a cinnamic acid group, a styryl group, a vinyl group, an allyl group, a vinyl ether group, a vinyl ester group), polymer structures formed by condensation polymerization, such as polyester, polyamide and polyamic acid structures, polymer structures formed by addition polymerization, such as a polyurethane structure, and cyclic structures of natural polymers such as cellulose, amylose and chitosan.

As the hydrophilic polymer having a hydrolyzable silyl group, it is especially preferred in the invention to use a polymer having at least one kind of structures represented by the following formulae (I) to (III).

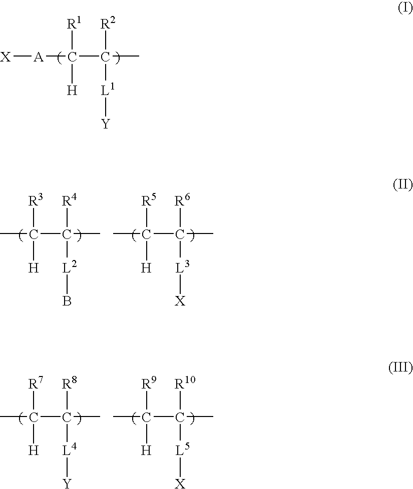

In formulae (I) to (III), R¹, R², R³, R⁴, R⁵, R⁶, R⁷, R⁸, R⁹ and R¹⁰ each represent a hydrogen atom or a hydrocarbon group independently, X represents a hydrolyzable silyl group (hereinafter referred to as a reactive group in some cases), A, L¹, L², L³, L⁴ and L⁵ each represent a single bond or a linkage group independently, and Y represents —NHCOR¹¹, —CONH₂, —CON(R¹¹)₂, —COR¹¹, —OH, —CO₂M, —SO₃M, —PO₃M, —OPO₃M or —N(R¹¹)₃Z¹. Herein, R¹¹ represents an alkyl group, an aryl group or an aralkyl group, M represents a hydrogen atom, an alkali metal, an alkaline earth metal or an onium and Z¹ represents a halogen ion. And B represents a group having a structure represented by the following formula (IV). The preferred carbon number of an alkyl group is 1 to 18.

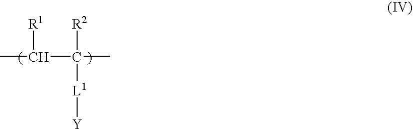

In formula (IV), R¹, R², L¹ and Y have the same meanings as in formula (I), respectively.

The hydrophilic polymer used in the invention has a reactive group and a hydrophilic group. One or more than one reactive group may be present at the main chain end of the polymer, or in side chains of the polymer.

“Reactive groups” can form chemical bonds by reacting with hydrolysis products and/or hydrolytic polycondensation products of metal alkoxides. In addition, reactive groups may form a chemical bond between themselves. It is preferable that the hydrophilic polymer is soluble in water, and what is more, it becomes insoluble in water by reacting with hydrolysis product and/or hydrolytic polycondensation products of metal alkoxides.

The term “chemical bond” as used herein has the same meaning as usual, and is intended to include a covalent bond, an ionic bond, a coordinate bond and a hydrogen bond. However, the chemical bond is preferably a covalent bond.

The hydrophilic polymer may have two or more reactive groups at one end thereof. These two or more reactive groups may be different from each other.

It is preferable that linkage groups intervene between repeating units in the hydrophilic polymer and reactive groups or between repeating units in the hydrophilic polymer and the polymer's main chain. The linkage groups A, L¹, L² and L³ each are preferably selected from not only a single bond or a linkage group explained below, but also —N<, an aliphatic group, an aromatic group, a heterocyclic group or combinations of these groups. The linkage group is preferably —O—, —S—, —CO— or —NH—, or includes a combination thereof.

### (Polymer Containing a Structure Represented by Formula (I))

A polymer containing a structure represented by formula (I) (also referred to as “hydrophilic polymer (I)”), that is a hydrophilic polymer having a reactive group at one end thereof, can be synthesized by polymerizing a hydrophilic monomer (e.g., acrylamide, acrylic acid, potassium salt of 3-sulfopropyl methacrylate) in the presence of a chain transfer agent (as described in Radical Polymerization Handbook, published by NTS Inc. under the joint editorship of Mikiharu Kamachi and Takeshi Endo) or an iniferter (as described in Macromolecules 1986, 19, p. 287—(Otsu)). Examples of a chain transfer agent include 3-mercaptopropionic acid, 2-aminoethanethiol hydrochloride, 3-mercaptopropanol, 2-hydroxyethyl disulfide and 3-mercaptopropyltrimethoxysilane. Alternatively, radical polymerization of a hydrophilic monomer (e.g., acrylamide) may be carried out using a radical polymerization initiator having a reactive group, instead of using a chain transfer agent.

The mass-average molecular weight of a hydrophilic polymer having a reactive group at one end thereof is preferably a million or below, far preferably from 1,000 to a million, particularly preferably from 2,000 to a hundred thousand.

The polymers containing a structure represented by formula (I) are polymers each having a reactive group at one end thereof. In formula (I), R¹ and R² each represent a hydrogen atom or a hydrocarbon group independently. The hydrocarbon group is preferably a hydrocarbon group containing 1 to 8 carbon atoms, with examples including an alkyl group and an aryl group. Of these groups, straight-chain, branched or cyclic alkyl groups containing at most 8 carbon atoms are preferred over the others. Examples of such alkyl groups include a methyl group, an ethyl group, a propyl group, a butyl group, a pentyl group, a hexyl group, a heptyl group, an octyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group and a cyclopentyl group. From the viewpoints of effects and availability, each of R¹ and R² is preferably a hydrogen atom, a methyl group or an ethyl group.

These hydrocarbon groups may further have substituents. When an alkyl group has a substituent, the substituted alkyl group is formed by combining an alkylene group and a substituent, and a univalent nonmetallic atom group, except for a hydrogen atom, is used as the substituent. Suitable examples of such a substituent include a halogen atom (—F, —Br, —Cl or —I), an alkoxy group, an aryloxy group, an alkylthio group, an arylthio group, an N-alkylamino group, an N,N-dialkylamino group, an acyloxy group, an N-alkylcarbamoyloxy group, an N-arylcarbamoyloxy group, an acylamino group, a formyl group, an acyl group, a carboxyl group, an alkoxycarbonyl group, an aryloxycarbonyl group, a carbamoyl group, an N-alkylcarbamoyl group, an N,N-dialkylcarbamoyl group, an N-arylcarbamoyl group, an N-alkyl-N-arylcarbamoyl group, a sulfo group, a sulfonato group, a sulfamoyl group, an N-alkylsulfamoyl group, an N,N-dialkylsulfamoyl group, an N-arylsulfamoyl group, an N-alkyl-N-arylsulfamoyl group, a phosphono group, a phosphonato group, a dialkylphosphono group, a diarylphosphono group, a monoalkylphosphono group, an alkylphosphonato group, a monoarylphosphono group, an arylphosphonato group, a phosphonoxy group, a phosphonatoxy group, an aryl group and an alkenyl group.

On the other hand, the alkylene group in a substituted alkyl group may be a divalent organic residue formed by removing any one hydrogen atom from the aforesaid alkyl group in which 1 to 8 carbon atoms are contained, and suitable examples thereof include a straight-chain alkylene group containing 1 to 12 carbon atoms, a branched alkylene group containing 3 to 12 carbon atoms and a cyclic alkylene group containing 5 to 10 carbon atoms. And suitable examples of a substituted alkyl group obtained by combining such a substituent and an alkylene group as recited above include a chloromethyl group, a bromomethyl group, a 2-chloroethyl group, a trifluoromethyl group, a methoxymethyl group, a methoxyethoxyethyl group, an allyloxymethyl group, a phenoxymethyl group, a methylthiomethyl group, a tolylthiomethyl group, an ethylaminoethyl group, a diethylaminopropyl group, a morpholinopropyl group, an acetyloxymethyl group, a benzoyloxymethyl group, an N-cyclohexylcarbamoyloxyethyl group, an N-phenylcarbamoyloxyethyl group, an acetylaminoethyl group, an N-methylbenzoylaminopropyl group, a 2-oxyethyl group, a 2-oxypropyl group, a carboxypropyl group, a methoxycarbonylethyl group, an allyloxycarbonylbutyl group, a chlorophenoxycarbonylmethyl group, a carbamoylmethyl group, an N-methylcarbamoylethyl group, an N,N-dipropylcarbamoylmethyl group, an N-(methoxyphenyl)carbamoylethyl group, an N-methyl-N-(sulfophenyl)carbamoylmethyl group, a sulfobutyl group, a sulfonatobutyl group, a sulfamoylbutyl group, an N-ethylsulfamoylmethyl group, an N,N-dipropylsulfamoylpropyl group, an N-tolylsulfamoylpropyl group, an N-methyl-N-(phosphophenyl)sulfamoyloctyl group, a phosphonobutyl group, a phosphonatohexyl group, a diethylphosphonobutyl group, a diphenylphosphonopropyl group, a methylphosphonobutyl group, a methylphosphonatobutyl group, a tolylphosphonohexyl group, a tolylphosphonatohexyl group, a phosphonoxypropyl group, a phosphonatoxybutyl group, a benzyl group, a phenethyl group, an α-methylbenzyl group, an 1-methyl-1-phenylethyl group, a p-methylbenzyl group, a cinnamyl group, an allyl group, a 1-propenylmethyl group, 2-butenyl group, a 2-methylallyl group, a 2-methylpropenylmethyl group, a 2-propynyl group, a 2-butynyl group and a 3-butynyl group.

A and L¹ each represent a single bond or an organic linkage group. The organic linkage group represented by A and L¹ each is a polyvalent linkage group made up of nonmetal atoms, specifically including 0 to 60 carbon atoms, 0 to 10 nitrogen atoms, 0 to 50 oxygen atoms, 0 to 100 hydrogen atoms and 0 to 20 sulfur atoms. Examples of such a linkage group include structural units illustrated below and combinations of any two or more of these structural units.

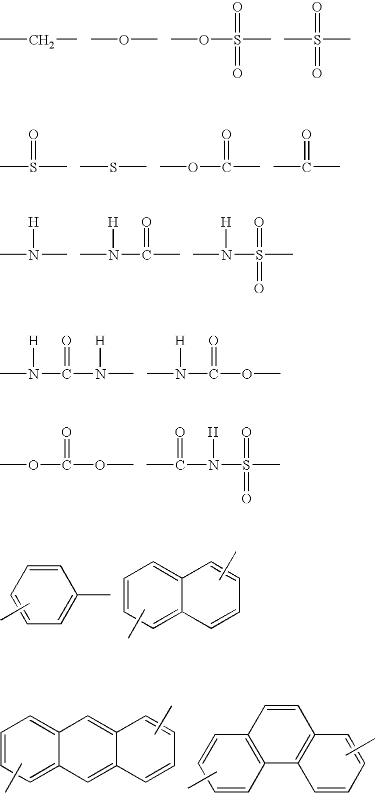

Y represents —NHCOR¹¹, —CONH₂, —CON(R¹¹)₂, —COR¹¹, —OH, —CO₂M, —SO₃M, —PO₃M, —OPO₃M or —N(R¹¹)₃Z¹. Herein, R¹¹ represents an alkyl group (preferably, 1-18C straight-chain, branched or cyclic alkyl group), an aryl group or an aralkyl group, M represents a hydrogen atom, an alkali metal, an alkaline earth metal or an onium, and Z¹ represents a halogen ion. When more than one R¹¹ is contained in the group represented by Y, such as —CON(R¹¹)₂, R¹¹s may combine with each other to form a ring, and the ring formed may be a hetero ring containing a hetero atom, such as an oxygen atom, a sulfur atom or a nitrogen atom. The group represented by R¹¹ may have a substituent. Examples of a substituent which can be introduced therein include the same ones as included in examples of substituents which can be introduced into alkyl groups as R¹ and R².

Examples of a group suitable as R¹¹ include a methyl group, an ethyl group, a propyl group, a butyl group, a pentyl group, a hexyl group, a heptyl group, an octyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methylhexyl group and a cyclopentyl group. M may be a hydrogen atom, an alkali metal such as lithium, sodium or potassium, an alkaline earth metal such as calcium or vanadium, or an onium such as ammonium, iodonium or sulfonium. Suitable examples of a group represented by Y include —NHCOCH₃, —CONH₂, —COOH, —SO₃⁻NMe₄⁺ and a morpholyl group.

Examples of a hydrophilic polymer that has the structure represented by formula (I) and can be used suitably in the invention are illustrated below (exemplified Compounds 1 to 13), but the invention should not be construed as being limited to these examples.

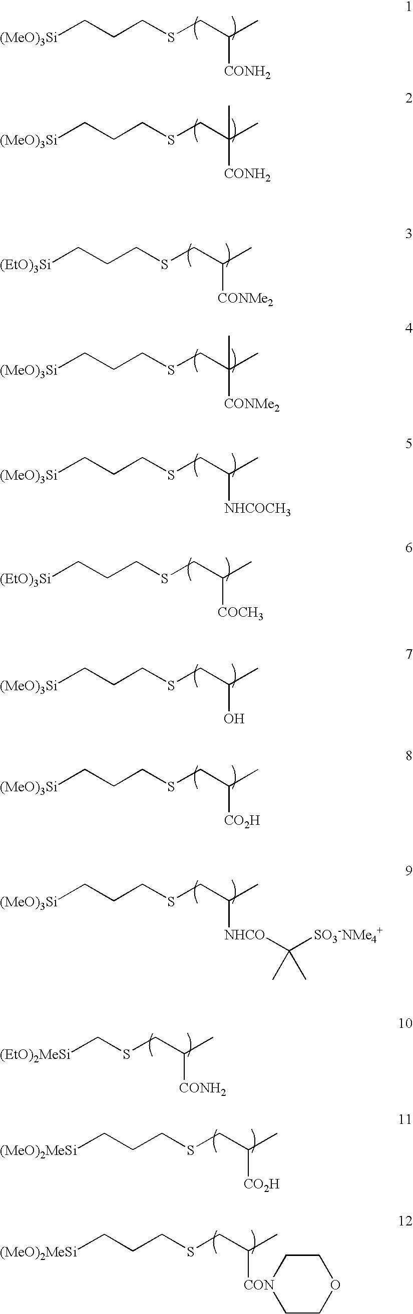

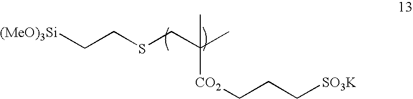

The hydrophilic polymers as illustrated above can be synthesized by radical polymerization carried out using radical polymerizable monomers represented by the following formula (i) and a silane coupling agent which is represented by the following formula (ii) and functions as a chain transfer in radical polymerization. Owing to the chain transfer function of the silane coupling agent (ii), polymers each having a main chain end into which a silane coupling group is introduced can be synthesized by radical polymerization.

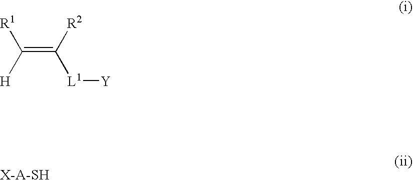

In the above formulae (i) and (ii), A, R¹, R², L¹, X and Y have the same meanings as in formula (1), respectively. Additionally, these compounds are commercially available, and can also be synthesized with ease.

### (Polymer Containing a Structure Represented by Formula (II))

As a polymer containing a structure represented by formula (II) (also referred to as “hydrophilic polymer (II)”), or a hydrophilic polymer having two or more reactive groups, it is possible to use a hydrophilic graft polymer formed by introducing hydrophilic group-containing side chains into its trunk polymer having reactive groups.

In formula (II), R³, R⁴, R⁵ and R⁶ each represent the same substituent as R¹ and R² each represent in formula (I). L² and L³ each have the same meaning as L¹ in formula (I). B is represented by formula (IV), and R¹, R², L¹ and Y in formula (IV) have the same meanings as those in formulae (I), respectively, and specific examples and preferred range are also the same. X has the same meaning as in formula (I).

Such a hydrophilic graft polymer can be generally produced by use of methods hitherto known as synthesis methods of graft polymers. More specifically, general methods for syntheses of graft polymers are described, e.g., in Fumio Ide, Graft Juugou to sono Ouyou, published by Koubunshi Kankoukai in 1977, and Shin Koubunshi Jikkengaku 2, Koubunshi no Gousei to Han-nou, published by Kyoritsu Shuppan Co., Ltd. in 1995 under the editorship of Koubunshi Gakkai (The Society of Polymer Science, Japan), and they are also applicable in the invention.

Synthesis methods of graft polymers can be classified basically under three groups, 1. methods of polymerizing a monomer so as to form molecular chains branching off from a trunk polymer, 2. methods of grafting a branch polymer onto a trunk polymer and 3. methods of copolymerizing a trunk polymer and a branch polymer (macromer methods). Although any method in these three groups allows production of hydrophilic graft polymers usable in the invention, “3. macromer methods” are superior from the viewpoints of production suitability and film structure control in particular.

The syntheses of graft polymers through the use of macromonomers are described in the book cited above, Shin Koubunshi Jikkengaku 2, Koubunshi no Gousei to Han-nou, published by Kyoritsu Shuppan Co., Ltd. in 1995 under the editorship of Koubunshi Gakkai. In addition, they are described in detail in Yu Yamashita et al., Macromonomer no Kagaku to Kougyou, published by Industrial Publishing & Consulting, Inc. in 1989. A graft polymer for use in the invention can be synthesized by copolymerizing a hydrophilic macromonomer synthesized in advance by the foregoing method (corresponding to precursors of hydrophilic polymer side chains) and a monomer having a reactive group.

### (Hydrophilic Macromonomer)

Particularly useful ones of hydrophilic macromonomers usable in the invention are macromonomers derived from monomers containing carboxyl groups, such as acrylic acid and methacrylic acid; macromonomers derived from sulfonic acid type monomers, such as 2-acrylamido-2-methylpropanesulfonic acid, vinylstyrenesulfonic acid and their salts; amide type macromonomers derived from acrylamide, methacrylamide and the like; amide type macromonomers derived from N-vinylcarboxylic acid amide monomers, such as N-vinylacetamide and N-vinylformamide; macromonomers derived from monomers containing hydroxyl groups, such as hydroxyethyl methacrylate, hydroxyethyl acrylate and glycerol monomethacrylate; and macromonomers derived from monomers containing alkoxy or ethylene oxide groups, such as methoxyethyl acrylate, methoxypolyethylene glycol acrylate and polyethylene glycol acrylate. In addition, monomers having polyethylene glycol chains or polypropylene glycol chains are also useful as macromonomers for use in the invention. Of these macromonomers, useful ones have their mass-average molecular weight in a range of 400 to a hundred thousand, preferably 1,000 to fifty thousand, particularly preferably 1,500 to twenty thousand. For securing effective hydrophilicity, it is appropriate that macromonomers have molecular weight of 400 or above, while it is also advantageous for macromonomers to have molecular weight of a hundred thousand or below because such macromonomers has a tendency to show high ability at polymerizing with comonomers to form main chains.

The suitable as the graft polymers are those having mass-average molecular weight of a million or below, preferably from 1,000 to one million, far preferably from twenty thousand to one hundred thousand. The molecular weight of one million or below is suitable because graft polymers having their molecular weight in such a range have no problem with their handling, and more specifically, they suffer from no degradation in solvent solubility at preparation of coating solutions for hydrophilic film formation, allow coating solutions to have low viscosity and easily form uniform film.

A polymer having the structure represented by formula (II) contains hydrophilic functional groups which are represented by Y in the formula and develop hydrophilicity. The more favorable it is that the higher functional group density the polymer has, because the higher surface hydrophilicity the polymer can have. The hydrophilic functional group density can be expressed in number of moles of functional group per gram of hydrophilic polymer, and it is preferably from 1 to 30 meq/g, far preferably from 2 to 20 meq/g, particularly preferably from 3 to 15 meq/g.

The copolymerization ratio in the polymer having the structure represented by formula (II) can be adjusted arbitrarily as long as the density of hydrophilic functional group Y falls within the above-specified range. More specifically, the ratio of the molar proportion of a monomer containing B (which is symbolized by m) to the molar proportion of a monomer containing X (which is symbolized by n), the m/n ratio, is preferably from 30/70 to 99/1, far preferably from 40/60 to 98/2, particularly preferably from 50/50 to 97/3. As long as m is its numerical value or greater in the ratio of m/n=30/70, there occurs no shortage of hydrophilicity; while, as long as n is its numerical value or greater in the ratio of m/n=99/1, sufficient quantity of reactive groups can be secured to result in attainment of sufficient hardening and film strength.

Examples of a polymer having the structure represented by the formula (II) (exemplified Compounds (1) to (50)), together with their individual mass-average molecular weight (M.W.), are illustrated below. However, these examples should not be construed as limiting the scope of the invention. Additionally, each of the following example polymers means a random or block copolymer containing the structural units as illustrated below in the molar proportions shown as their respective numerical subscripts.

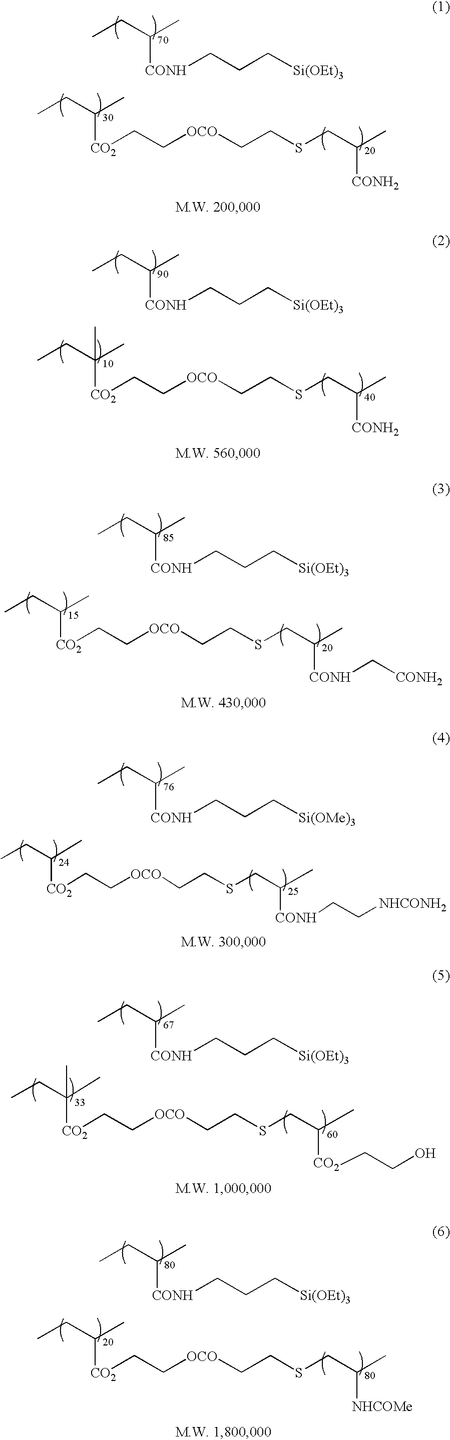

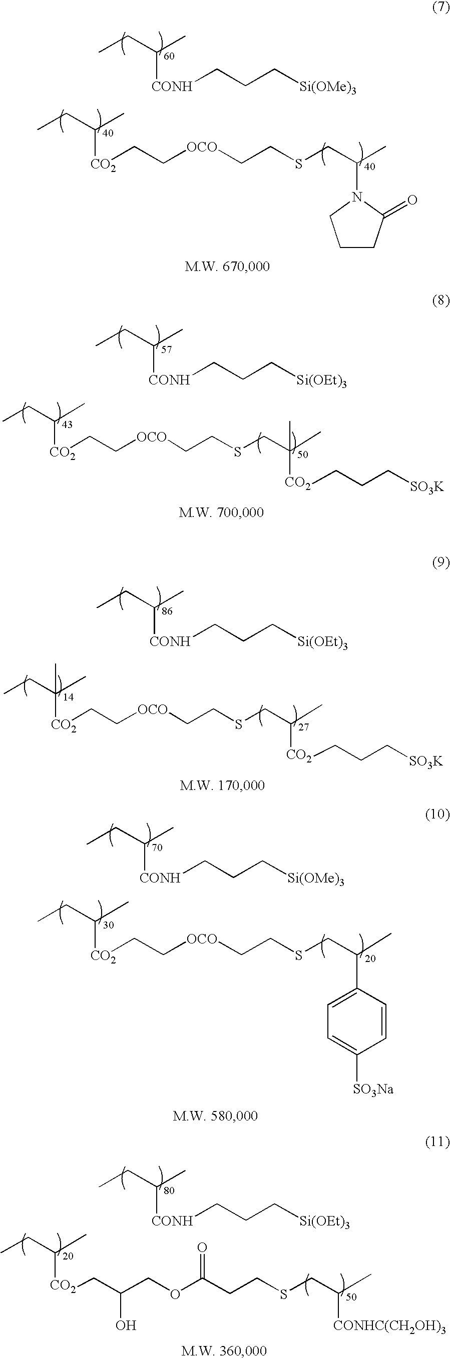

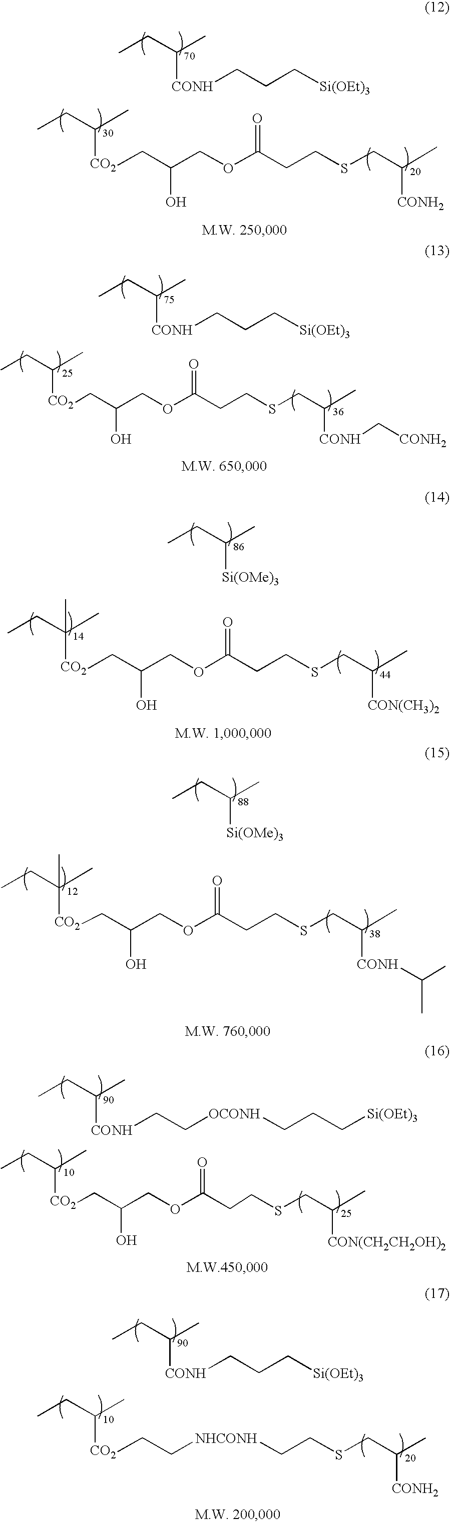

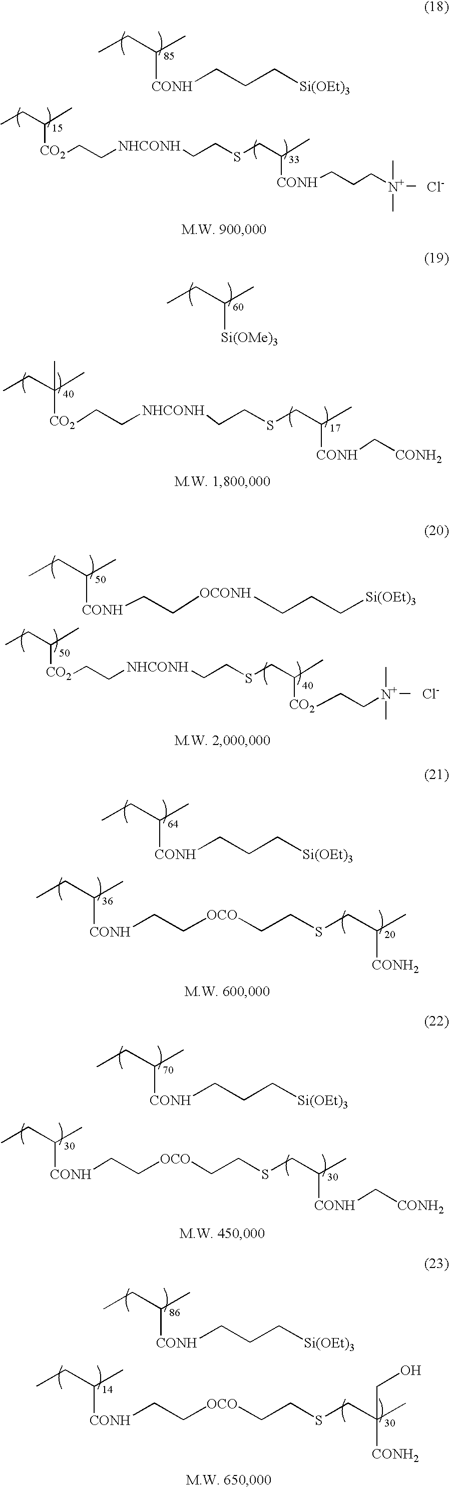

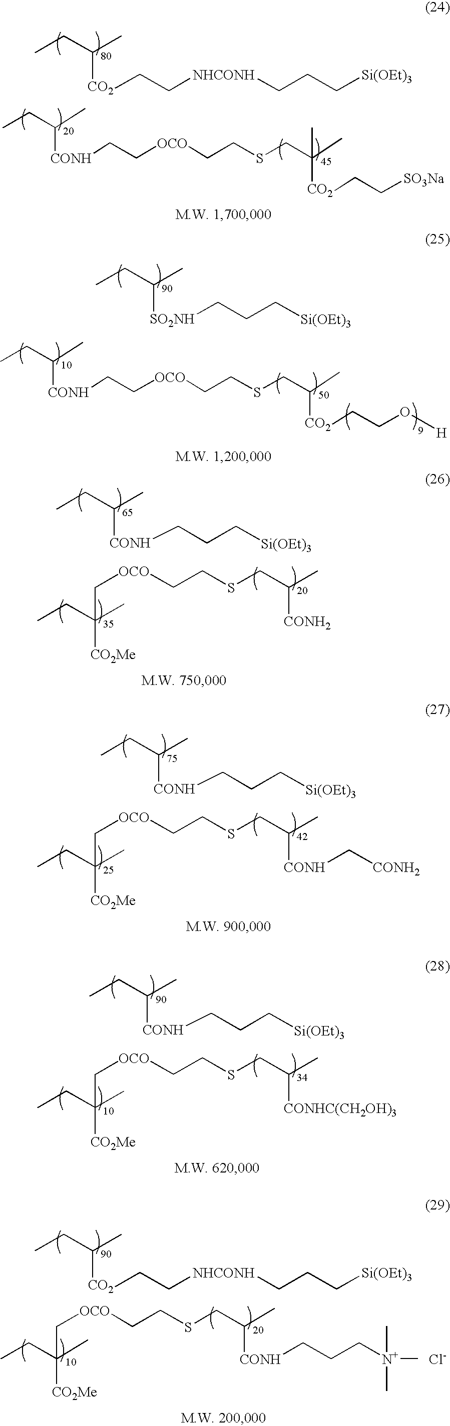

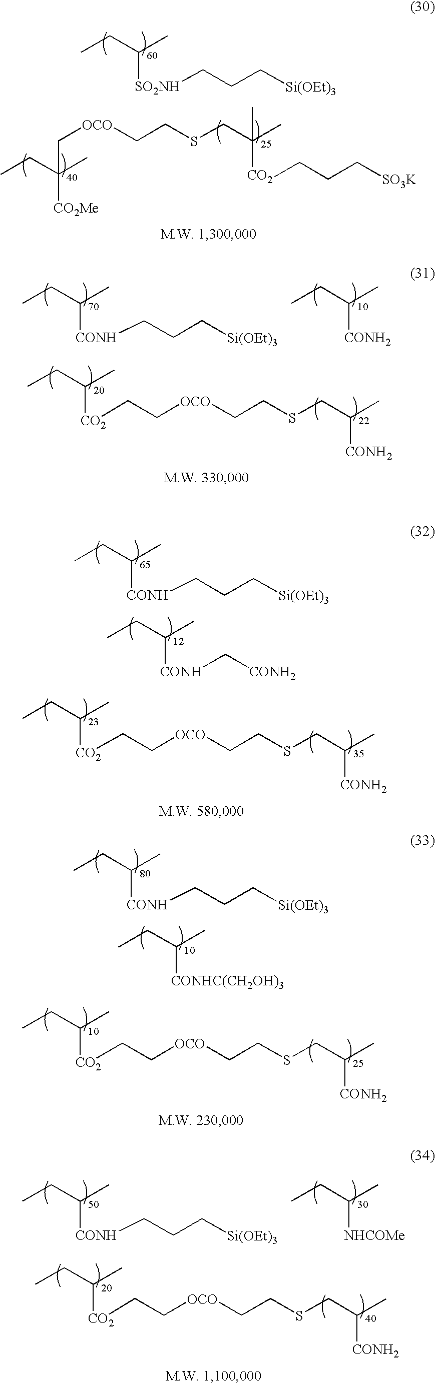

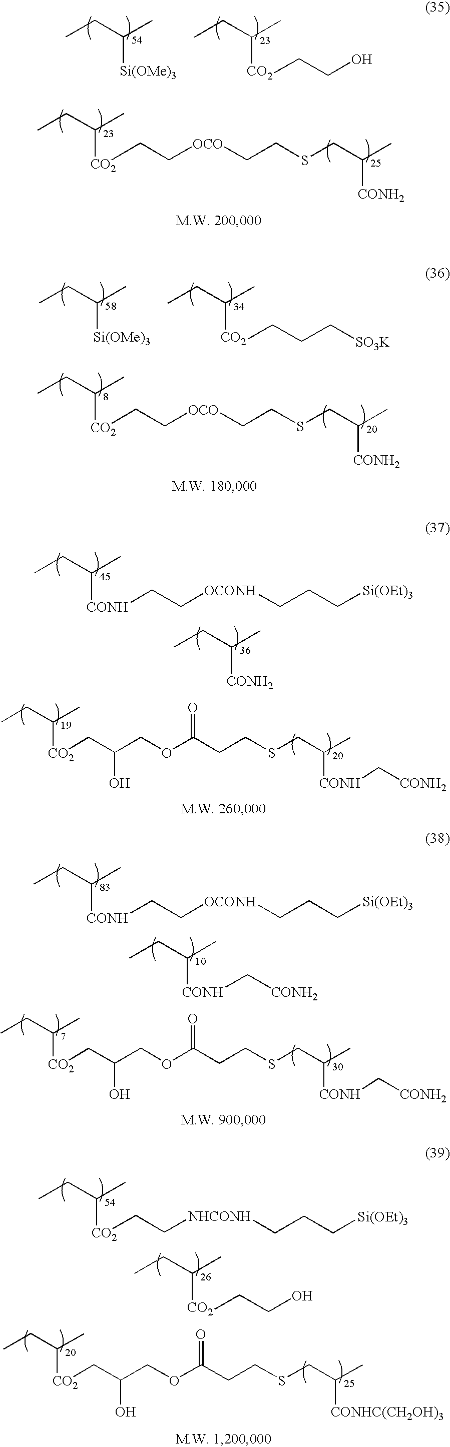

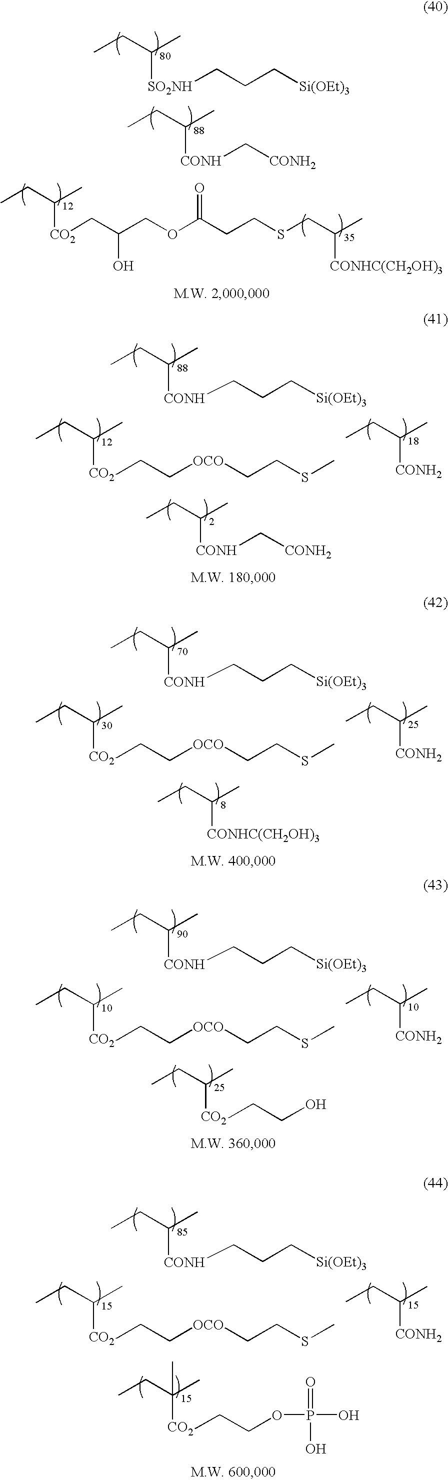

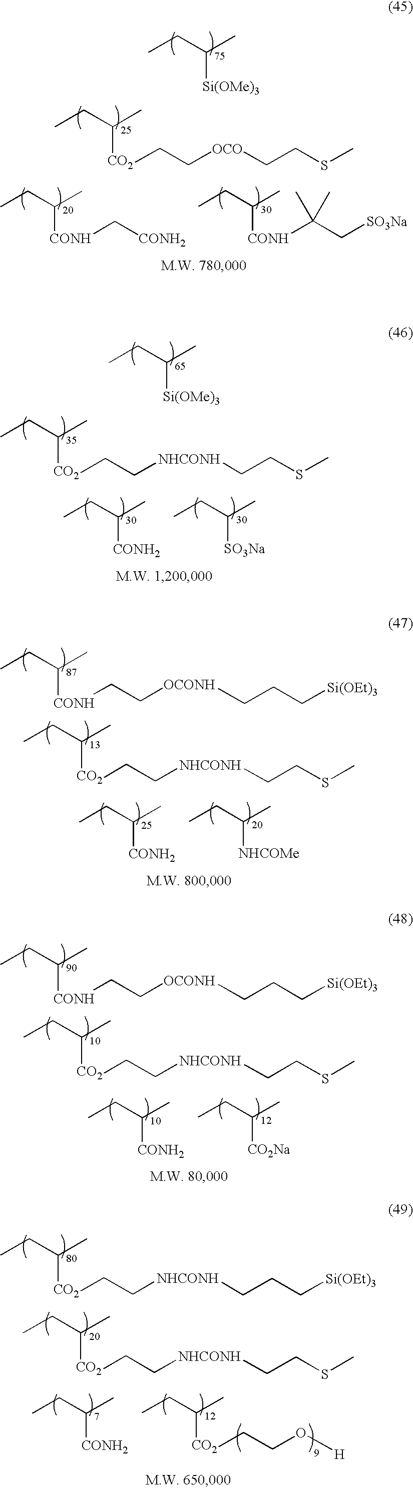

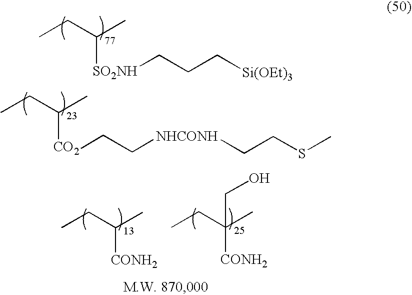

The polymers having the structures represented by the formula (II) may be copolymers containing additional structural units derived from other monomers. Examples of other monomers usable for the copolymers include known monomers such as acrylic acid esters, methacrylic acid esters, acrylamides, methacrylamides, vinyl esters, styrenes, acrylic acid, methacrylic acid, acrylonitrile, maleic anhydride and maleimide. By use of such monomers as comonomers, various physical properties including film formability, film strength, hydrophilicity, hydrophobicity, solubility, reactivity and stability can be improved.

### (Polymer Having Structure Represented by Formula (III))

In formula (III), R⁷, R⁸, R⁹ and R¹⁰ are independent of one another, and they each represent the same substituent as each of R¹ and R² in formula (I) represents. L⁴ and L⁵ each have the same meaning as L¹ in formula (I). Y and X are the same as those in Formula (I) and Formula (II), respectively. In point of high hydrophilicity, it is preferable in the invention that L⁵ is a single bond or a linkage group having at least one structure selected from the group consisting of —CONH—, —NHCONH—, —OCONH—, —SO₂NH— and —SO₃—.

Examples of a polymer containing a structure represented by formula (III) (also referred to as “hydrophilic polymer (III)”) (exemplified Compounds (1) to (50)), together with their individual mass-average molecular weight (M.W.), are illustrated below. However, these examples should not be construed as limiting the scope of the invention. Additionally, each of the following example polymers means a random copolymer or block copolymer having structural units as illustrated below in molar proportions shown as numerical subscripts.

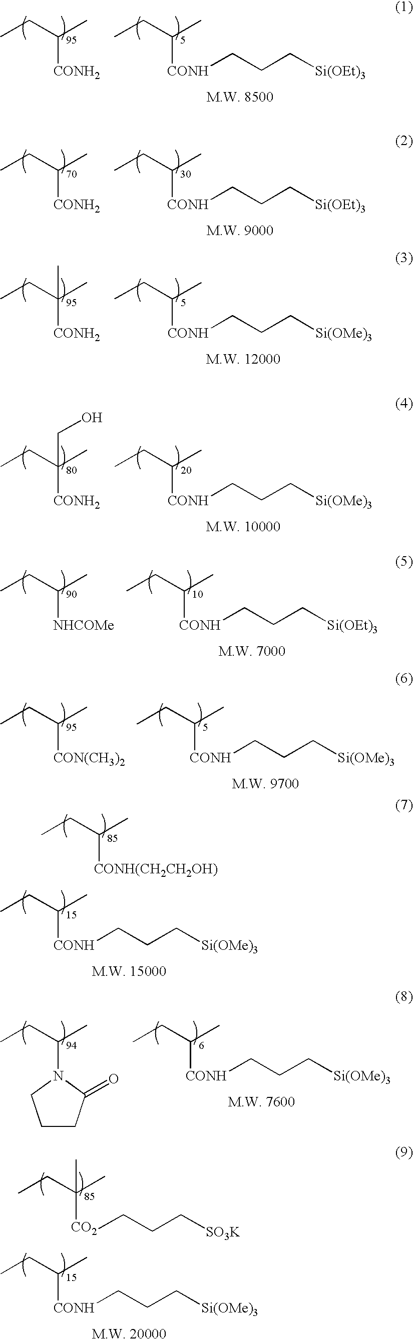

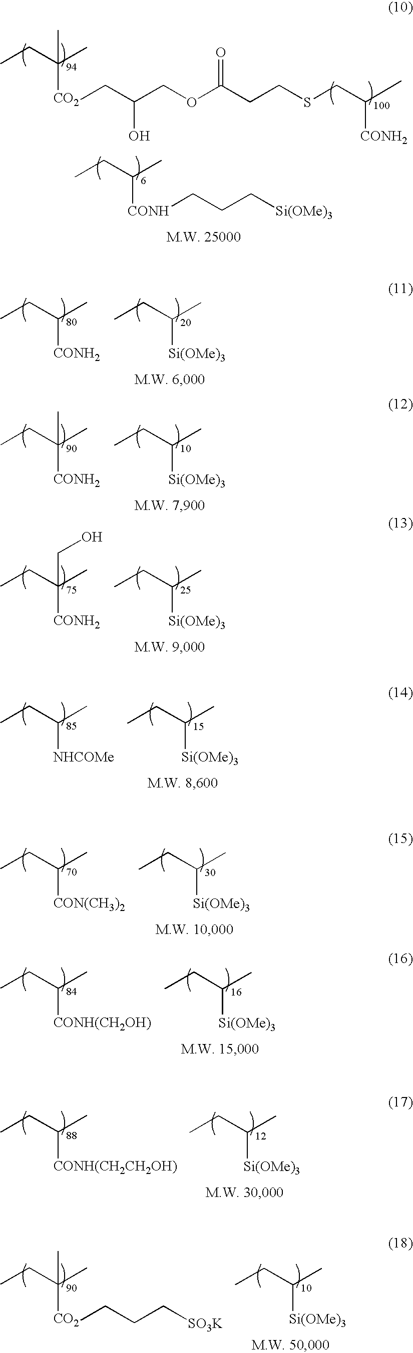

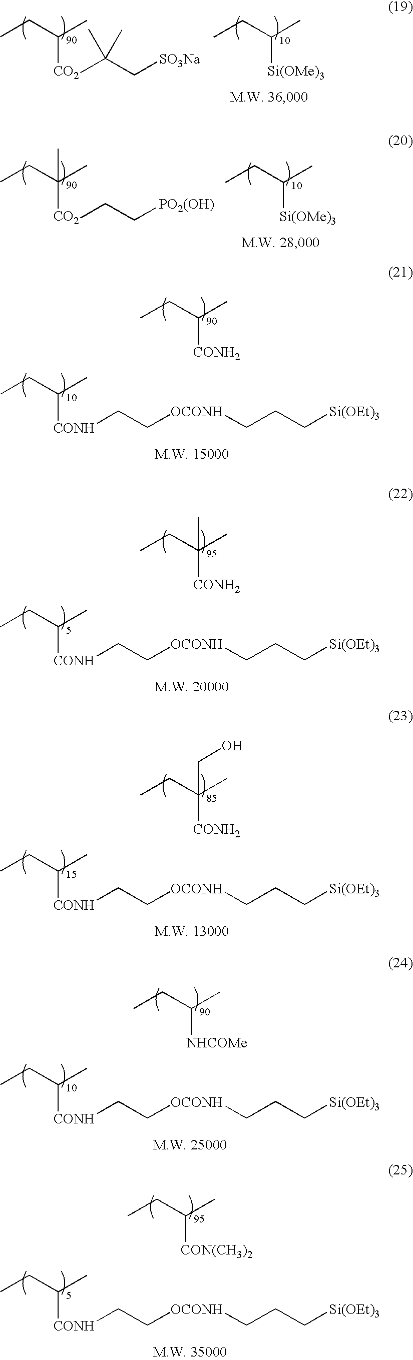

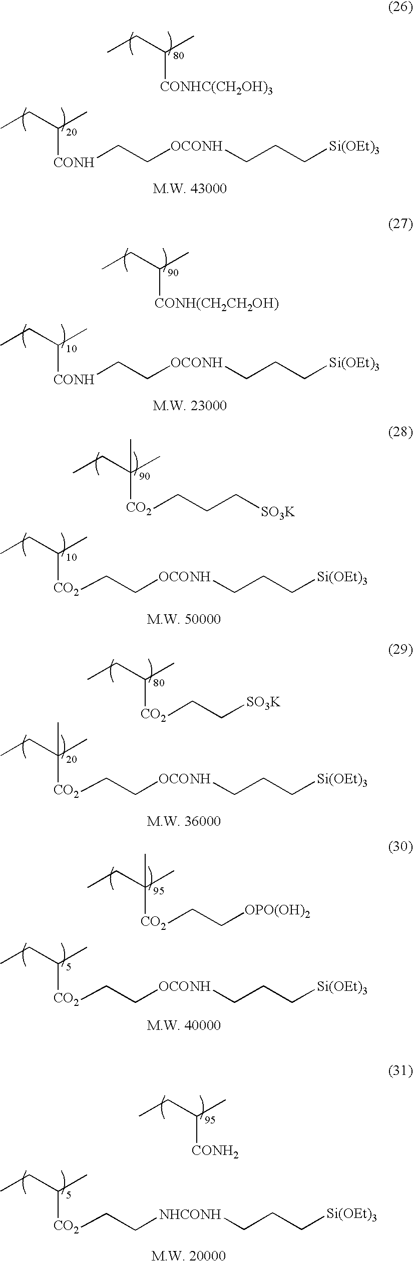

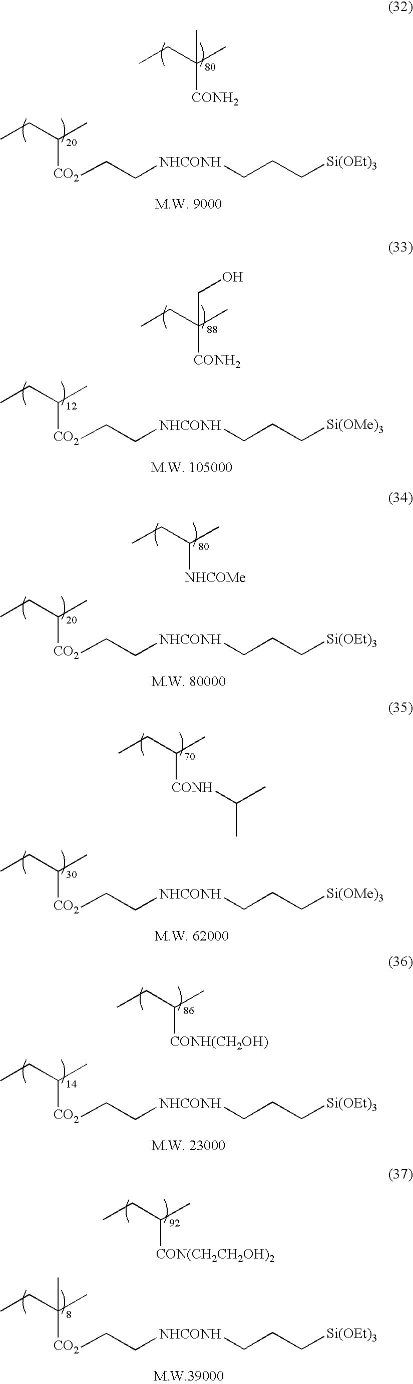

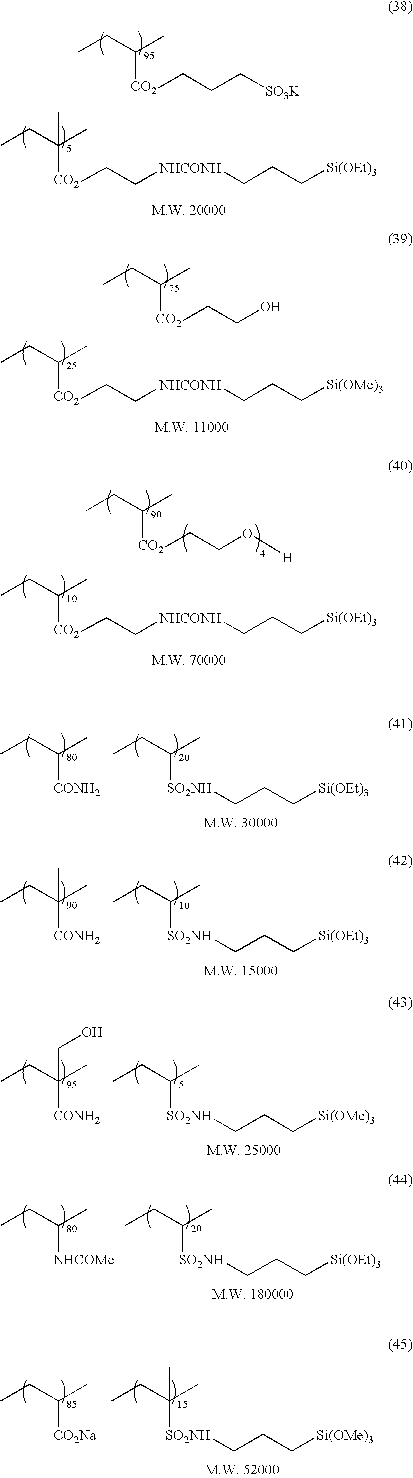

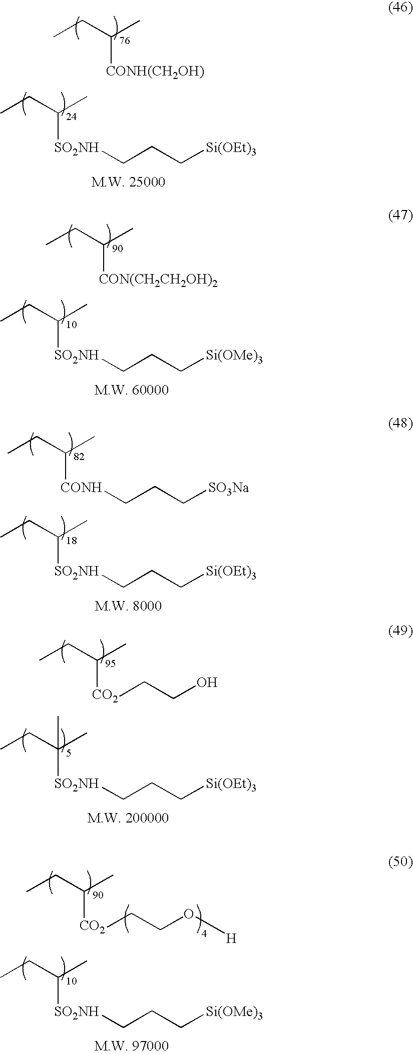

Various compounds usable for syntheses of polymers having the structures represented by formula (III) are commercially available, and they can also be synthesized with ease.

To radial polymerization for syntheses of polymers having the structures represented by formula (III), any of methods hitherto known can be applied. More specifically, typical radical polymerization methods are described, e.g., in Shin-Koubunshi Jikkengaku 3, Koubunshi no Gousei to Han-nou 1, published by Kyoritsu Shuppan Co., Ltd. under the editorship of Koubunshi Gakkai, Shin Jikken Kagaku Kouza 19, Koubunshi Kaga (I), published by Maruzen Co., Ltd. under the editorship of Nihon Kagakukai (The Chemical Society of Japan), and Busshitsu Kougaku Kouza, Koubunshi Gousei Kagaku (I), published by Tokyo Denki University Press, and they are applicable in the invention.

Moreover, the polymers having the structures represented by formula (III) may be copolymers including additional structural units derived from other monomers. Examples of other monomers usable for the copolymers include known monomers such as acrylic acid esters, methacrylic acid esters, acrylamides, methacrylamides, vinyl esters, styrenes, acrylic acid, methacrylic acid, acrylonitrile, maleic anhydride and maleimide. By use of such monomers as comonomers, various physical properties including film formability, film strength, hydrophilicity, hydrophobicity, solubility, reactivity and stability can be improved.

The mass-average molecular weight of a polymer having the structure represented by formula (III) is preferably from 1,000 to 1,000,000, far preferably from 1,000 to 500,000, particularly preferably from 1,000 to 200,000.

The hydrophilic polymers as illustrated above can form cross-linked film in a state of being mixed with hydrolysis products and/or hydrolytic polycondensation products of metal alkoxides. The hydrophilic polymers as the organic component are concerned in film strength and film flexibility, and can provide satisfactory film properties especially when the viscosity thereof is in a range of 0.1 mPa·s to 100 mPa·s (as measured in the form of a 5% aqueous solution at 20° C.), and the range is preferably from 0.5 mPa·s to 70 mPa·s, far preferably from 1 mPa·s to 50 mPa·s.

In the present two-liquid composition, it is preferable in terms of water resistance and antifouling properties that (I) a hydrophilic polymer having a structure represented by formula (I) and (II) a hydrophilic polymer having a structure represented by formula (II) or (III) a hydrophilic polymer having a structure represented by formula (III) are included in combination. In general, it is anticipated that mixing of a hydrophilic polymer (I) with a hydrophilic polymer (II) or (III) will have a potential for lowering adhesiveness and water resistance. But, contrary to such anticipation, the invention has allowed achievement of unexpected effect of enhancing water resistance and antifouling properties while ensuring hydrophilicity of the two-liquid composition by adjusting the mass ratio between the hydrophilic polymer (I) and the hydrophilic polymer (II) or the hydrophilic polymer (III) to fall within a specified range.

More specifically, the range of the hydrophilic polymer (I)/hydrophilic polymer (II) or (III) ratio by mass is preferably from 50/50 to 5/95, far preferably from 40/60 to 10/90.

### (Metal Alkoxide Compound)

In addition, the first liquid composition (A) preferably contains a metal alkoxide compound. As the metal alkoxide compound, compounds represented by the following formula (VI) are suitable.

(R¹³)ₖ-Q-(OR¹⁴)₄₋ₖ (VI)

In formula (VI), R¹³ represents a hydrogen atom, an alkyl group or an aryl group, R¹⁴ represents an alkyl group or an aryl group, Q represents Si, Al, Ti or Zr, and k represents an integer of 0 to 2. When R¹³ and R¹⁴ each represent an alkyl group, the number of carbon atoms contained therein is preferably from 1 to 4. The alkyl or aryl group may have a substituent, and examples of a substituent which can be introduced into such a group include a halogen atom, an amino group and a mercapto group. Additionally, the metal alkoxide compounds are low-molecular compounds, and the molecular weight thereof is preferably 1,000 or below.

Examples of metal alkoxide compounds represented by formula (VI) are recited below, but the invention should not be construed as being limited to these examples. Examples of a metal alkoxide compound in the case where Q is Si, or a metal alkoxide compound containing silicon, include trimethoxysilane, triethoxysilane, tripropoxysilane, tetramethoxysilane, tetraethoxysilane, tetrapropoxysilane, methyltrimethoxysilane, ethyltriethoxysilane, propyltrimethoxysilane, methyltriethoxysilane, ethyltriethoxysilane, propyltriethoxysilane, dimethyldimethoxysilane, diethyldiethoxysilane, γ-chloropropyltriethoxysilane, γ-mercaptopropyltrimethoxysilane, γ-mercaptopropyltriethoxysilane, γ-aminopropyltriethoxysilane, phenyltrimethoxysilane, phenyltriethoxysilane, phenyltripropoxysilane, diphenyldimethoxysilane and diphenyldiethoxysilane. Of these alkoxysilanes, especially preferred ones include tetramethoxysilane, tetraethoxysilane, methyltrimethoxysilane, ethyltrimethoxysilane, methyltriethoxysilane, ethyltriethoxysilane, dimethyldiethoxysilane, phenyltrimethoxysilane, phenyltriethoxysilane, diphenyldimethoxysilane and diphenyldiethoxysilane.

Examples of a metal alkoxide compound in the case where Q is Al, or a metal alkoxide compound containing aluminum, include trimethoxyaluminate, triethoxyaluminate, tripropoxyaluminate and tetraethoxyaluminate.

Examples of a metal alkoxide compound in the case where Q is Ti, or a metal alkoxide compound containing titanium, include trimethoxytitanate, tetramethoxytitanate, triethoxytitanate, tetraethoxytitanate, tetrapropoxytitanate, chlorotrimethoxytitanate, chlorotriethoxytitanate, ethyltrimethoxytitanate, methyltriethoxytitanate, ethyltriethoxytitanate, diethyldiethoxytitanate, phenyltrimethoxytitanate and phenyltriethoxytitanate.

Examples of a metal alkoxide compound in the case where Q is Zr, or a metal alkoxide compound containing zirconium, include zirconates which correspond to the compounds recited above except that zirconium is substituted for titanium.

Of the metal alkoxide compounds recited above, the metal alkoxide compounds in which silicon is contained as Q are preferred over the others in point of film formability.

The metal alkoxide compounds relating to the invention may be used alone or as combinations of two or more thereof.

In the first liquid solution (A), it is appropriate that metal alkoxide compound(s) be used as a non-volatile component in a content of 5 to 80 mass %, preferably 10 to 70 mass %. (In this specification, mass ratio is equal to weight ratio.)

The metal alkoxide compounds as recited above are easy to get as commercial products, and it is also possible to synthesize them by known methods, e.g., reaction of various metal chlorides with alcohol compounds.

Such metal alkoxide compounds may be used as they are, or in the form of hydrolysis products and/or hydrolytic condensation products. In the case of using a metal alkoxide compound in the form of a hydrolysis product and/or a hydrolytic condensation product, the metal alkoxide compound, though may be used after it has undergone hydrolysis and condensation, is preferably used in a condition that it is hydrolyzed and condensed by addition of the right amount of water at time of preparing a composition by mixing it with the remainder of the composition.

When a metal alkoxide compound is used in the form of a condensation product, it is appropriate that the condensation product have weight-average molecular weight (hereinafter abbreviated as “Mw” of 300 to 100,000, preferably 400 to 70,000, particularly preferably 1,000 to 50,000, as calculated in terms of polystyrene. When the condensation product has its Mw in a range of 1,000 to 50,000, it can contribute particularly to improvement in the ability of the present composition to harden.

### Second Liquid Composition (B)

The second liquid composition (B) used in the invention contains a catalyst capable of accelerating the reaction of hydrolyzable silyl groups as illustrated above.

As the catalyst, it is preferable to use, e.g., an acid and a metal chelate or salt in combination. By such a combined use, hydrolysis reaction proceeds speedily upon mixing of the first liquid composition (A) with the second liquid composition (B), and besides, condensation reaction progresses rapidly by heating. As a result, hydrophilic film of very high strength can be formed

### (Acid)

Examples of an acid usable for the catalyst include acetic acid, chloroacetic acid, citric acid, benzoic acid, dimethylmalonic acid, formic acid, propionic acid, glutaric acid, glycolic acid, maleic acid, malonic acid, hydrochloric acid, sulfuric acid, nitric acid, phosphoric acid, oxalic acid, p-toluenesulfonic acid and phthalic acid. Of these acids, hydrochloric acid and nitric acid are preferred over the others.

### (Metal Chelate)

Examples of a metal chelate usable for the catalyst include compounds formed from metal elements chosen from the group 2A, 3B, 4A or 5A in the periodic table and oxo- or hydroxy oxygen-containing compounds selected from β-diketones, ketoesters, hydroxycarboxylic acids or esters thereof, aminoalcohol compounds or enolic active hydrogen-containing compounds.

As constituent metal elements, the group 2A elements including Mg, Ca, Sr and Ba, the group 3B elements including Al and Ga, and the group 5A elements including V, Nb and Ta are suitable, and these metal elements form complexes capable of producing excellent catalytic effect. Of these complexes, the complexes formed from Zr, Al and Ti are superior in catalytic effect and can be used to advantage.

Examples of an oxo- or hydroxy oxygen-containing compound forming a ligand of the metal chelate usable in the invention include β-diketones, such as acetylacetone (2,4-pentanedione) and 2,4-heptanedione; ketoesters, such as methyl acetoacetate, ethyl acetoacetate and butyl acetoacetate; hydroxycarboxylic acids and esters thereof, such as lactic acid, methyl lactate, salicylic acid, ethyl salicylate, phenyl salicylate, malic acid, tartaric acid and methyl tartarate; ketoalcohol compounds, such as 4-hydroxy-4-methyl-2-pentanone, 4-hydroxy-2-pentanone, 4-hydroxy-4-methyl-2-heptanone and 4-hydroxy-2-heptanone; aminoalcohol compounds, such as monoethanolamine, N,N-dimethylethanolamine, N-methyl-monoethanolamine, diethanolamine and triethanolamine; enolic active compounds, such as methylolmelamine, methylolurea, methylolacrylamide and diethyl malonate; and compounds having substituents at the position of the methyl, methylene or carbonyl carbon of acetylacetone (2,4-pentanedione).

Of these ligands, the preferable are acetylacetone or acetylacetone derivatives. In the invention, the term acetylacetone derivatives refer to compounds having substituents at the position of the methyl, methylene or carbonyl carbon of acetylacetone. Examples of a substituent that the methyl of acetylacetone can have are a straight-chain or branched alkyl group, an acyl group, a hydroxyalkyl group, a carboxyalkyl group, an alkoxy group and an alkoxyalkyl group, each of which contains 1 to 3 carbon atoms. Examples of a substituent that the methylene of acetylacetone can have are a carboxyl group and a straight-chain or branched carboxyalkyl or hydroxyalkyl group containing 1 to 3 carbon atoms. One example of a substituent that the carbonyl carbon of acetylacetone can have is an alkyl group containing 1 to 3 carbon atoms. In this case, the carbonyl oxygen is converted into a hydroxyl group by addition of a hydrogen atom.

Examples of an acetylacetone derivative suitable for use in the invention include ethylcarbonylacetone, n-propylcarbonylacetone, i-propylcarbonylacetone, diacetylacetone, 1-acetyl-1-propionyl-acetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone and diacetone alcohol. Of these compounds, acetylacetone and diacetylacetone are particularly preferred to the others. The complex formed from an acetylacetone derivative as recited above and a metal element as recited above is a mononuclear complex formed by coordinating 1 to 4 molecules of acetylacetone derivative per metal element. When the coordination-capable number of the metal element is greater than the sum total of coordinate bonding hands of the acetylacetone derivative molecules coordinated, general-purpose ligands used in ordinary complexes, such as water molecule, halogen ion, nitro group and ammonio group, may be coordinated.

Examples of a metal chelate suitable for use in the invention include tris(acetylacetonato(acac))aluminum complex salt, di(acetylacetonato)aquoaluminum complex salt, mono(acetylacetonato)chloroaluminum complex salt, di(diacetylacetonato)aluminum complex salt, aluminum ethylacetoacetate diisopropylate, aluminum tris(ethylacetoacetate), cyclic aluminum oxide isopropylate, tris(acetylacetonato)barium complex salt, di(acetylacetonato)titanium complex salt, tris(acetylacetonato)titanium complex salt, di-i-propoxybis(acetylacetonato)titanium complex salt, zirconium tris(ethylacetoacetate), and zirconium tris(benzoate) complex salt. These complexes are superior in stability in water-base coating solutions and gelation accelerating effect in sol-gel reaction under heat drying. Among them, aluminum ethylacetatoacetate diisopropylate, aluminum tris(ethylacetoacetate), di(acetylacetonato)titanium complex salt and zirconium tris(ethylacetoacetate) in particular are preferred to the others.

### (Metal Salt)

Metal salts can also be used in place of the metal chelates as illustrated above. Examples of typical metal salts include halides, oxyacid salts and organic acid salts of metal elements selected from the groups 2A, 3B, 4A and 5A of the periodic table.

Of such metal elements, the group 2A elements such as Mg, Ca, Sr and Ra, the group 3B elements such as Al and Ga, the group 4A elements such as Ti and Zr, and the group 5A elements such as V, Nb and Ta are preferred over the others, and they each form metal salts having excellent catalytic effect. The metal salts formed from Zr and Al in particular are superior to the others in catalytic effect, and used to advantage.

Suitable examples of such metal salts include ZrOCl₂.8H₂O, ZrOSO₄.nH₂O, ZrO(NO₃)₂.4H₂O, ZrO(CO₃)₂.nH₂O, ZrO(OH)₂.nH₂O, ZrO(C₂H₃O₂)₂, (NH₄)₂ZrO(CO₃)₂, ZrO(C₁₈H₂₅O₂)₂, ZrO(C₈H₁₅O₂)₂, AlCl₃, Al₂O₃.H₂O, Al₂O₃.3H₂O, Al₂(SO₄)₃.18H₂O and Al₂(C₂O₄)₃.4H₂O.

Combinations of acids and metal chelates or metal salts are described below. Each combination has no particular restrictions, and it can be chosen appropriately according to its application and the kind of a substrate used. As to the acid used, hydrochloric acid or nitric acid is preferable, while the preferred ones among metal chelates and metal salts include aluminum ethylacetoacetate diisopropylate, aluminum tris(ethylacetoacetate), di(acetylacetonato)titanium complex salt, zirconium tris(ethylacetoacetate), ZrOCl₂.8H₂O, ZrO(NO₃)₂.4H₂O and AlCl₃. It is appropriate that the foregoing acids be combined with any of the metal chelates or metal salts recited above.

The addition amount of a catalyst used (the proportion of a catalyst contained) in the second liquid composition (B) is described below. The addition amount of a catalyst is not particularly limited, but it is appropriate in ordinary cases that the catalyst be contained in an amount of 0.1 to 15 parts by mass per 100 parts by mass of the hydrophilic polymer contained in the first liquid composition (A). When the first liquid composition (A) contains a metal alkoxide, it is preferable that the addition amount of the catalyst is generally adjusted to fall within the range of 0.1 to 20 parts by mass per 100 parts by mass of combination of a hydrophilic polymer and a metal alkoxide and/or its hydrolysis products in the first liquid composition (A). When the addition amount of the catalyst is smaller than 0.1 parts by mass, the ability of the composition to harden is lowered, and there are cases where sufficient hardening speed cannot be attained. On the other hand, when the addition amount of the catalyst is greater than 20 parts by mass, there are cases where the resultant hardened matter suffers degradation in hydrophilicity. Therefore, from the viewpoint of attaining a better balance between hardening capabilities and the hydrophilicity of the resultant hardened matter, it is preferable that the addition amount of the catalyst is adjusted to fall within the range of 1 to 10 parts by mass per 100 parts by mass of combination of a hydrophilic polymer and a metal alkoxide and/or its hydrolysis products.

### (Usage)

The first liquid composition (A) and the second liquid composition (B) of the present two-liquid composition are mixed together to prepare a hydrophilic composition, and a hydrophilic film is formed by coating a substrate with the hydrophilic composition. It is preferable that the second liquid composition (B) is mixed into the first liquid composition (A), although this is not normally envisaged since there are concerns that the generation of aggregates and the increase of viscosity due to the proceeding of the local reaction when two liquids of the two-liquid composition are mixed are not sufficiently suppressed. This is because the addition of the first liquid composition (A) to the second liquid composition (B) causes such a state that the second liquid composition (B) is present in an excess amount at time of starting the addition, which results in possible development of aggregates. Further, it is preferable that one liquid is added to the other under stirring. For attaining homogeneous mixture, it is appropriate that, after the mixing, stirring be continued over a one-minute to one-hour period. In addition, it is advantageous for the mixing to be carried out at a temperature of 5° C. to 40° C.

Furthermore, in order to completely suppress the generation of aggregates and the increase of viscosity, at the time of mixing two liquids, it is important to mix the liquids immediately and homogeneously, therefore the viscosity of the first liquid composition (A) is preferably 100 mPa·s or below at 20° C. In addition, it is also preferable that the hydrophilic composition is prepared by mixing the second liquid composition (B) into the first liquid composition (A) under stirring at the revolution speed of 100 rpm or above.

Then, the content proportion (by mass) between an acid and a metal chelate and that between an acid and a metal salt are described. These content proportions each have no particular limitations, but it is appropriate that the content proportion between an acid and a metal chelate or a metal salt be adjusted to fall within the range of 0.1:95 to 50:50. When the proportion of an acid contained is greater than 50, there are cases where degradation in liquid stability occurs after mixing the first liquid composition (A) and the second liquid composition (B). On the other hand, when the proportion of an acid contained is smaller than 0.5, there are cases where hydrolysis of a hydrophilic polymer, a metal alkoxide and/or its hydrolysis products does not occur speedily to result in insufficient hardening. Therefore, from the viewpoint of attaining a better balance between hardening capabilities and liquid stability, it is preferable that the content proportion between an acid and a metal chelate or a metal salt is adjusted to a value within the range of 0.5:95 to 30:70.

### (Inorganic Fine Particles)

The present second liquid composition may contain inorganic fine particles for the purposes of enhancing hydrophilicity, preventing the film formed from cracking and increasing film strength.

Examples of inorganic fine particles suitable for the foregoing purposes include silica, alumina, magnesium oxide, titanium oxide, magnesium carbonate, calcium alginate and mixtures of two or more thereof.

The average diameter of inorganic fine particles ranges preferably from 2 nm to 10 μm, far preferably from 10 nm to 3 μm. When the average particle diameter is within the range specified above, the inorganic fine particles are dispersed with stability into the layer formed from the present two-liquid composition (hydrophilic layer), and contribute to satisfactory retention of film strength of the hydrophilic layer and to formation of a hydrophilic member with high durability and excellent hydrophilicity.

Of the inorganic fine particles as recited above, colloidal silica dispersion in particular is preferable to the others, and it is easy to get as a commercial product.

The content of inorganic fine particles is preferably 80 mass % or below, far preferably 50 mass % or below, with respect to the total solids in the hydrophilic layer.

It is preferable to add inorganic fine particles to the first liquid composition (A).

### (Other Ingredients)

Various kinds of additives that can be used in the present two-liquid composition as required are described below.

### 1) Surfactant

To the present two-liquid composition, a surfactant may be added.

Examples of such a surfactant include the surfactants disclosed in JP-A-62-173463 and JP-A-62-183457, and more specifically, they include anionic surfactants, such as dialkylsulfosuccinic acid salts, alkylnaphthalenesulfonic acid salts and fatty acid salts; nonionic surfactants, such as polyoxyethylene alkyl ethers, polyoxyethylene alkyl aryl ethers, acetylene glycols and polyoxyethylene-polyoxypropylene block copolymers; and cationic surfactants, such as alkylamines and quaternary ammonium salts. Instead of using these surfactants, organic fluorine compounds may be used. The organic fluorine compounds used are preferably hydrophobic. Examples of such organic fluorine compounds include fluorine-containing surfactants, fluorine compounds in an oil state (e.g., fluorocarbon oil), and fluorocarbon resins in a solid state (e.g., tetrafluoroethylene resin), and more specifically, they include those disclosed in JP-B-57-9053 (columns 8 trough 17) and JP-A-62-135826.

### 2) Ultraviolet Absorbent

From the viewpoint of enhancing weather resistance and durability of a hydrophilic member, an ultraviolet absorbent can be used in the present two-liquid composition.

Examples of such an ultraviolet absorbent include the benzotriazole compounds disclosed, e.g., in JP-A-58-185677, JP-A-61-190537, JP-A-2-782, JP-A-5-197075 and JP-A-9-34057, the benzophenone compounds disclosed, e.g., in JP-A-46-2784, JP-A-5-194483 and U.S. Pat. No. 3,214,463, the cinnamic acid compounds disclosed, e.g., in JP-B-48-30492, JP-B-56-21141 and JP-A-10-88106, the triazine compounds disclosed, e.g., in JP-A-4-298503, JP-A-8-53427, JP-A-8-239368, JP-A-10-182621, JP-T-8-501291 (the term “JP-T” as used herein means a published Japanese translation of a PTC patent application), the compounds disclosed in Research Disclosure, No. 24239, and the compounds generating fluorescence by absorbing ultraviolet rays, typified by stilbene compounds and benzoxazole compounds, the so-called fluorescent whiteners.

The amount of such an ultraviolet absorbent to be added is chosen as appropriate in accordance with the intended purpose, and it is commonly preferable that the ultraviolet absorbent is present in the hydrophilic layer in a content of 0.5 to 15 mass % on a solids basis.

### 3) Antioxidant

To the present two-liquid composition an antioxidant can be added for the purpose of improving the stability. Examples of an antioxidant suitable for such a purpose include the compounds disclosed in EP-A-223739, EP-A-309401, EP-A-309402, EP-A-310551, EP-A-310552, EP-A-459416, DE-A-3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The amount of such an antioxidant to be added is chosen appropriately in accordance with the intended purpose. Specifically, it is preferable that the content of an antioxidant in the hydrophilic layer is from 0.1 to 8 mass % on a solids basis.

### 4) Solvent

For the purpose of securing formability of uniform coating on a substrate at the time of forming a hydrophilic layer of the present hydrophilic member, it is also effective to add an organic solvent in a moderate amount to the present two-liquid composition.

Examples of a solvent usable for such a purpose include ketone solvents, such as acetone, methyl ethyl ketone and diethyl ketone; alcohol solvents, such as methanol, ethanol, 2-propanol, 1-propanol, 1-butanol and tert-butanol; chlorine-containing solvents, such as chloroform and methylene chloride; aromatic solvents, such as benzene and toluene; ester solvents, such as ethyl acetate, butyl acetate and isopropyl acetate; ether solvents, such as diethyl ether, tetrahydrofuran and dioxane; and glycol ether solvents, such as ethylene glycol monomethyl ether and ethylene glycol dimethyl ether.

The addition of such a solvent is effective within the quantitative limitation beyond which troubles related to VOC (volatile organic solvent) will occur, and more specifically, the solvent is added in an amount of preferably from 0 to 50 mass %, far preferably from 0 to 30 mass %, based on the total amount of the present two-liquid composition.

### 5) Macromolecular Compound

For the purpose of controlling film properties of the hydrophilic layer to be formed, various kinds of macromolecular compounds can be added to the present two-liquid composition so long as they cause no hydrophilicity loss. Examples of such a macromolecular compound include acrylic polymers, polyvinyl butyral resins, polyurethane resins, polyamide resins, polyester resins, epoxy resins, phenol resins, polycarbonate resins, polyvinyl formal resins, shellac, vinyl resins, acrylic resins, gum resins, waxes and other natural resins. Any two or more of these resins may be used in combination. Of those resins, vinyl copolymers obtained by copolymerization of acrylic monomers are preferred over the others. Further, where the compositions of copolymers for polymeric binder are concerned, copolymers containing structural units derived from carboxyl group-containing monomers and alkyl methacrylates or alkyl acrylates can also be used to advantage.

To the present two-liquid composition, it is possible to further add, e.g., a leveling additive and a matting agent as required, waxes for controlling film properties, and a tackifier for improvement in adhesiveness to a substrate, only in an amount causing no impairment of hydrophilicity.

Examples of a tackifier which can be added include the high-molecular-weight tacky polymers disclosed in JP-A-2001-49200, pp. 5-6 (such as copolymers prepared from (meth)acrylic acid esters of alcohol compounds having 1-20C alkyl groups, (meth)acrylic acid esters of 3-14C alicyclic alcohol compounds and (meth)acrylic acid esters of 6-14C aromatic alcohol compounds), and low-molecular-weight tackiness imparting resin having polymerizable unsaturated bonds.

In addition, other than above, as long as the objects and effects of the invention are not impaired, additives such as radical polymerization initiator, photosensitizing agent, polymerization prohibiting agent, polymerization initiation aid, wettability improving agent, plasticizer, charge preventing agent, silane coupling agent, antiseptic agent, pigment, drying agent, precipitation preventing agent, drip preventing agent, thickening agent, antiskinning agent, color separation preventing agent, lubricating agent, deforming agent, antiadhesive agent, delustering preventing agent, flame retardant and antirust agent can be Her contained.

The amount of a tackifier to be added is chosen as appropriate in accordance with the intended purpose. In general, its suitable content in the hydrophilic layer is from 0.5 to 15 weight % on a solids basis.

For the various additives used when needed, it is advantageous to be added to the first liquid composition (A).

### (Hydrophilic Member)

A hydrophilic member according to the invention has on a substrate a hydrophilic film formed by coating the substrate with a two-liquid composition including a first liquid composition (A) that contains a hydrophilic polymer having a hydrolyzable silyl group and a second liquid composition (B) that contains a catalyst capable of accelerating reaction of the hydrolyzable silyl group and then drying the two-liquid composition.

An acid, one constituent of the catalyst, is fast in hardening speed at ordinary temperatures, while a metal chelate or a metal salt, the other constituent of the catalyst, is slow in hardening speed at ordinary temperatures. Therefore, the mixture may be heated after coating. Thus, the mixture can initiate hydrolysis reaction speedily to result in acceleration of hardening reaction. As to the application method of the present two-liquid composition, there is no particular restriction, and any of known methods may be used. Examples of methods usable herein include coating methods, such as a roll coating method, a spin coating method, a dip coating method, a spray coating method, a flow coating method and a gravure coating method; and vapor-phase methods, notably a physical vapor deposition (PVD) method and a chemical vapor deposition (CVD) method, such as a vacuum evaporation method, a reactive evaporation method, an ion-beam assist method, a sputtering method and an ion plating method. Of these methods, any of roll coating, spin coating, dip coating, spray coating and flow coating methods are preferable to the others because they have high possibilities of thickness control of film, from thin film to thick film.

The heating temperature and time have no particular limitations so long as the solvent contained in a sol-state liquid can be eliminated and strong film can be formed, but it is preferable in point of production suitability that the heating temperature is 150° C. or below and the heating time is one hour or fewer.

### (Substrate)

The present two-liquid composition can be applied to a broad variety of substrates including glass, stone, ceramic, wood, synthetic resin and metal. When a substrate is coated with the present composition, the substrate, though may be used as it is in unprocessed condition, can get in advance surface treatment for imparting hydrophilicity to one side or both sides thereof as required for enhancement of adhesiveness to the hydrophilic layer formed from the present composition. Examples of a treatment method for imparting hydrophilicity to the substrate surface include corona discharge treatment, glow discharge treatment, chromic acid treatment (wet), flame treatment, hot-air treatment, ozone-UV irradiation treatment, alkaline wash, sand blast, and brush polishing.

When the present hydrophilic member uses a transparent substrate in expectation of antifouling and/or antifogging effect, substrates pervious to visible light, such as inorganic substrates including glass and glass containing an inorganic compound layer, a transparent plastic substrate and a transparent plastic substrate containing an inorganic compound layer, are suitable for use as materials for the transparent substrate.

To mention the inorganic substrates in detail, a usual glass plate, a laminated glass plate containing a resin layer, a gas layer, a vacuum layer and the like, and various kinds of glass plates containing reinforcing ingredients, coloring agents and so on can be given as examples thereof.

Examples of a glass plate containing an inorganic compound layer include glass plates with inorganic compound layers formed from metallic oxides such as silicon oxide, aluminum oxide, magnesium oxide, titanium oxide, tin oxide, zirconium oxide, sodium oxide, antimony oxide, indium oxide, bismuth oxide, yttrium oxide, cerium oxide, zinc oxide and ITO (Indium Tin Oxide), or metal halides such as magnesium fluoride, calcium fluoride, lanthanum fluoride, cerium fluoride, lithium fluoride and thorium fluoride.

Such inorganic compound layers each can be configured to have a single-layer or multilayer structure. Depending on the thickness, each inorganic compound layer allows retention of perviousness to light in some instances, but allows action as an antireflective layer in other instances. To the formation of inorganic compound layers are applicable known methods including coating methods, such as a dip coating method, a spin coating method, a flow coating method, a spray coating method, a roll coating method and a gravure coating method; and vapor-phase methods, notably a physical vapor deposition (PVD) method and a chemical vapor deposition (CVD) method, such as a vacuum evaporation method, a reactive evaporation method, an ion-beam assist method, a sputtering method and an ion plating method.

Examples of a transparent plastic substrate among organic substrates like plastics include substrates formed from various plastic materials pervious to visible light. The substrate to be used as an optical material in particular is selected with consideration given to its optical characteristics including transparency, refractive index and dispersivity. Depending on the end-use purpose, further considerations in selecting the substrate to be used are given to physical properties including strength-related physical characteristics, such as shock resistance and flexibility, heat resistance, weather resistance and durability. Examples of a material suitable for the substrate from those points of view include polyolefin resins such as polyethylene and polypropylene, polyester resins such as polyethylene terephthalate and polyethylene naphthalate, polyamide resins, polystyrene, polyvinyl chloride, polyimide, polyvinyl alcohol, polyethylene-vinyl alcohol, acrylic resins, and cellulose resins such as triacetyl cellulose, diacetyl cellulose and cellophane. Depending on the purpose of use, those materials may be used alone or combinations of any two or more of them can also be used in the form of mixture, copolymer or laminate.

As the transparent plastic substrates, it is also possible to use plastic plates on which are formed the inorganic compound layers as recited in the description of glass plates. Herein, each inorganic compound layer formed may also be made to act as an antireflective layer. At the occasion of forming inorganic compound layers on transparent plastic substrates, the same techniques as used in the case of inorganic substrates may also be adopted.

Between an inorganic compound layer and a transparent plastic substrate, a hard coating layer may be formed. By forming the hard coating layer, the substrate surface is improved in hardness and becomes smooth. So, adhesiveness between the transparent plastic substrate and the inorganic compound layer is enhanced, and it becomes possible to increase scratch-proof strength and prevent appearance of cracks in the inorganic compound layer which results from bending of the substrate. By use of such a substrate, the hydrophilic member formed can obtain an improvement in mechanical strength. The hard coating layer has no particular restrictions as to its material so long as it has transparency, a moderate hardness and a mechanical strength. For example, resins curable by irradiation with ionizing radiation or ultraviolet rays and thermosetting resins can be used. More specifically, ultraviolet cure acrylic resins and organosilicon resins, and thermosetting polysiloxane resins in particular can be used to advantage. The refractive indexes of these resins are preferably equivalent or approximate to those of transparent plastic substrates.

The method of applying such a hard coating layer has no particular restrictions, and any method can be adopted as long as it allows application of a uniform coating. The hard coating layer can have sufficient strength when it has a thickness of 3 μm or above, but in view of transparency, coating accuracy and handing, it is advantageous for the hard coating layer to range in thickness from 5 to 7 μm. Further, the hard coating layer can be given light diffusion treatment generally referred to as antiglare treatment by mixing and dispersing therein inorganic or organic particles having an average diameter of 0.01 to 3 μm. These particles have no particular restrictions except that transparency is required of them, but it is preferable that their material has a low refractive index. Specifically, silicon oxide and magnesium fluoride in particular are preferable in terms of stability and heat resistance. The light diffusion treatment can also be achieved by providing asperities on the surface of the hard coating layer.

As described above, the present hydrophilic member can be obtained by using as its substrate a glass or transparent plastic substrate having an inorganic compound layer and forming on the substrate a hydrophilic film from the present two-liquid composition. By having a hydrophilic film having excellent hydrophilicity and durability on its surface, the hydrophilic member can impart either excellent antifouling properties, notably protection against oils-and-fats fouling, or excellent antifogging properties, or both to its substrate surface.

### (Surface Free Energy)

In its general purpose, hydrophilicity is measured by a contact angle of a waterdrop. However, there are cases where contact angles of waterdrops on the very highly hydrophilic surfaces as attained in the invention are 10° or below, possibly 5° or below. So, there are limitations to mutual comparisons among degrees of hydrophilicity. On the other hand, surface free energy measurement is adopted for detailed evaluation of the degree of hydrophilicity that a solid surface has. And various methods for surface free energy measurement have been proposed. In the invention, surface free energy measurement is made in accordance with, for example, the Zisman plot method.

More specifically, the Zisman plot method utilizes a property that the surface tension of an aqueous solution of inorganic electrolyte, such as magnesium chloride, increases with concentration of the solution. After contact angle measurement is made by use of the water solution in the air at room temperature, the surface tension of the water solution is plotted as abscissa, and the value of the contact angle expressed in cos θ terms as ordinate. These data on water solutions having different concentrations are plotted to form a linear relationship, and the surface tension corresponding to cos θ=, or contact angle=0, is defined as surface free energy of a solid. The surface tension of water is 72 mN/m. The greater the value of surface free energy, the higher the hydrophilicity.

When a hydrophilic layer has its surface free energy in a range of 70 mN/m to 95 mN/n, preferably 72 mN/m to 93 mN/m, far preferably 75 mN/m to 90 mN/m, as measured in accordance with the foregoing method, the hydrophilic layer has excellent hydrophilicity and can deliver good performance.

When the hydrophilic member coated with the present hydrophilic film is applied to (used as or stuck on) windowpane or the like, the transparency thereof is important from the viewpoint of ensuring visibility. The present hydrophilic layer allows compatibility between transparency and durability because it is so highly transparent that almost no loss of transparency occurs even when its thickness is increased. The thickness of the present hydrophilic layer is preferably from 0.01 μm to 100 μm, far preferably from 0.05 μm to 50 μm, particularly preferably from 0.1 μm to 20 μm. The thickness of 0.0 μm or above is preferred because it allows attainment of sufficient hydrophilicity and durability, while the thickness of 100 μm or below is preferred because it causes no problem in film formability, e.g., no cracking.

The transparency is evaluated by spectrophotometric measurements of light transmittance in the visible region (400 nm to 800 nm). The light transmittance is preferably from 100% to 70%, far preferably from 95% to 75%, particularly preferably from 95% to 80%. By having the light transmittance in such a range, the hydrophilic member coated with the present hydrophilic film can be applied for various uses.

Furthermore, at least one undercoating layer can be provided between a substrate and the hydrophilic layer. Examples of a material used for the undercoating layer include metal oxide film, hydrophilic resin and water-dispersible latex.

Examples of a material for the metal oxide film include SiO₂, Al₂O₃, ZrO₂ and TiO₂, and these films can be formed by a sol-gel method, a sputtering method or a vapor deposition method.

Examples of the hydrophilic resin include polyvinyl alcohol (PVA) resins, cellulose resins [e.g., methyl cellulose (MC), hydroxyethyl cellulose (HEC), carboxymethyl cellulose (CMC)], chitin, chitosan, starch, resins having ether linkages [e.g., polyethylene oxide (PEO), polyethylene glycol (PEG), polyvinyl ether (PVE)], and resins having carbamoyl groups [e.g., polyacrylamide (PAAM), polyvinyl pyrrolidone (PVP)]. In addition to these resins, resins having carboxyl groups, such as polyacrylic acid salts, maleic acid resin, alginic acid salts and gelatins, may also be included.

Of the resins recited above, resins of at least one kind selected from polyvinyl alcohol (PVA) resins, cellulose resins, resins having ether linkages, resins having carbamoyl groups, resins having carboxyl groups or gelatins are used to advantage, and polyvinyl alcohol (PVA) resins or gelatins in particular are preferred to the others.

Examples of the water-dispersible latex include acrylic latex, polyester latex, NBR latex, polyurethane latex, polyvinyl acetate latex, SBR latex and polyamide latex. Of these latexes, acrylic latex is preferred over the others.

The hydrophilic resins as recited above may be used alone or as combinations of any two or more thereof. Likewise, the water-dispersible latexes as recited above may be used alone or as combinations of any two or more thereof. In addition, those chosen from the hydrophilic resins and the water-dispersible latexes, respectively, may be used in combination.

Further, a cross-linking agent capable of forming cross-links between the hydrophilic resins as recited above or in the water-dispersible latex as recited above may be used.

Cross-linking agents applicable to the invention include known cross-linking agents capable of thermally forming cross-links. Descriptions of thermally cross-linking agents for general uses can be found, e.g., in Shinzo Yamashita & Tousuke Kaneko, Kakyouzai Handbook, Taiseisha, Ltd. (1981). The cross-linking agents which may be used in the invention have no particular restrictions so long as each agent has at least two functional groups and can effectively bring about cross-linking reaction with the hydrophilic resins or the water-dispersible latexes. Examples of thermally cross-lining agents usable in the invention include polycarboxylic acids, such as polyacrylic acid; amine compounds, such as polyethylneimine; polyepoxy compounds, such as ethylene or propylene glycol diglycidyl ether, tetraethylene glycol diglycidyl ether, nonaethylene glycol diglycidyl ether, polyethylene or polypropylene glycol glycidyl ether, neopentyl glycol diglycidyl ether, 1,6-hexanediol diglycidyl ether, trimethylolpropane triglycidyl ether, and sorbitol polyglycidyl ether; polyaldehyde compounds, such as glyoxal and terephthalaldehyde; tolylene diisocyanate, hexamethylene diisocyanate, diphenylmethane isocyanate, xylylene diisocyanate, polymethylenepolyphenyl isocyanate, cyclohexanephenylene diisocyanate, naphthalene-1,5-diisocyanate, isopropylbenzene-2,4-diisocyanate, and polyisocyanate compounds such as polypropylene glycol/tolylene diisocyanate addition product, and block polyisocyanate compounds; silane coupling agents, such as tetraalkoxysilane; metallic cross-linking agents, such as acetylacetonates of aluminum, copper and iron(III); and polymethylol compounds, such as trimethylolmelanine and pentaerythritol. Of these thermally cross-linking agents, water-soluble ones are preferable from the viewpoints of easiness of preparation of coating solutions and prevention of a drop in hydrophilicity of the hydrophilic layer formed.

The total content of the hydrophilic resins and/or water-dispersible latexes in the undercoating layer is preferably from 0.01 to 20 g/m², far preferably from 0.1 to 10 g/m².

The surface of the present hydrophilic member may also be provided with an antireflective layer. Antireflective layers applicable thereto are not limited to the inorganic compound layers as recited above. For example, known antireflective layers of the type which each get antireflective effect by laminating two or more thin layers differing in reflectivity and refractive index can be used as appropriate. As materials for such thin layers, both inorganic and organic compounds can be used. In a particular case where a substrate having on its surface an inorganic compound layer as an antireflective layer is adopted, application of the hydrophilic layer involved in the invention to the substrate surface on the antireflective layer side allows attainment of not only outstanding antifouling and antifogging functions but also very excellent antireflective properties on the resultant hydrophilic member surface. Furthermore, it is also possible to obtain an antireflective, optically-functional member having various functions and properties by bonding the hydrophilic member of the foregoing layer structure and a functional optical member, such as a polarizing plate, together by a bonding technique, typified by lamination.

By sticking any of those antireflective members or antireflective, optically-functional members on, e.g., glass plates, plastic plates or polarizing plates of the front screens of display devices of various types (e.g., a liquid crystal display, a CRT display, a projection display, a plasma display, an EL display) with the aid of an adhesive or a binding agent, application of such an antireflective member to a display device becomes possible.

Besides being applied to the display devices as recited above, the present hydrophilic member can be applied to various uses in which antifouling and/or antifogging effects are required. Additionally, when it is intended to apply the antifouling and/or antifogging member to a substrate which is in no need of transparency, any of metal, ceramic, wood, stone, cement, concrete, fiber, fabric, and combinations or laminates of these materials can be used as a support substrate in addition to the transparent substrates as recited above.

Examples of uses to which substrates pervious to visible light are applicable, which constitute one application area of the present hydrophilic members, include mirrors, such as rearview mirrors of cars, mirrors for use in bathrooms, washstand mirrors, dental mirrors and road mirrors; lenses, such as lenses of spectacles, contact lenses, optical lenses, photographic objectives, endoscope lenses, lenses for use in lighting, lenses for use in semiconductor equipment and lenses for use in copiers; prisms; windowpanes of buildings and lookout towers; windowpanes of carriages, such as cars, rail cars, aircraft, boats an ships, submarines, snowmobiles, ropeway gondolas, amusement-park gondolas and spacecraft; windshields of carriages, such as cars, rail cars, aircraft, boats and ships, submarines, snowmobiles, motorcycles, ropeway gondolas, amusement-park gondolas and spacecraft; protective goggles, sporting goggles, goggles for motorbike riders, protective mask shields, sports mask shields, helmet shields, frozen foods showcases, finders for cameras and display glass; cover glass for measuring instruments including meters, cover glass for image sensors including CCD and CMOS, and film to be stuck to the surfaces of the articles as recited above.

Other applicable uses are of great variety, and examples thereof include construction materials, exteriors of buildings, interiors of buildings, window sashes, windowpanes, fin materials of heat exchangers for air conditioners, structural members, exteriors and coatings of carriages, exteriors of mechanical devices and articles, dust-resistant covers and coatings, traffic signs, various display devices, advertising towers, road sound abatement shields, railroad soundproof walls, bridges, exteriors and coatings of guardrails, interiors and coatings of tunnels, insulators, solar cell covers, heat collecting covers of solar water heaters, sensors of analyzers, vinyl houses, panel light covers of cars, home accommodations, toilets, tiles, siding, bathtubs, washstands, lighting fixtures, illumination covers, kitchen utensils, dishes, dish washers, dish driers, sinks, faucets, kitchen ranges, kitchen hoods, range hoods, ventilating fans, stoves, and film to be stuck to the articles as recited above; housings, components, exteriors and coatings of electric appliances for home use, housings, components, exteriors and coatings of office automation equipment products, and film to be stuck to the articles as recited above; fibers for diapers and filters; and undercoating agents for various paints and functional films.

Of the uses recited above, application of the present hydrophilic members to fin materials, particularly to a fin material made from aluminum, is preferred over the others. In other words, it is preferable to coat a fin material (preferably an aluminum fin material) with the present two-liquid composition, and thereby to form a hydrophilic layer of the two-liquid composition at the fin material surface.

Aluminum fin materials used in heat exchangers for room air conditioners or car air conditioners cause degradation in cooling capabilities during the cooling operation, because aggregated water produced during the cooling grows into water drops and stays between fins to result in formation of water bridges. In addition, dust gets deposited between fins, and thereby degradation in cooling capabilities is also caused. With these problems in view, the present hydrophilic members are applied to fin materials, and thereby excellent hydrophile and antifouling properties and long persistence of these properties are imparted to the fin materials.

It is preferred that the fin materials according to the invention have water contact angles of 40° or below after they are subjected to 5 cycles of treatment including exposure to palmitic acid gas for 1 hour, washing with water for 30 minutes and drying for 30 minutes.

An example of aluminum which can be used for a fin material is an aluminum plate whose surface has undergone degreasing treatment and, when required, chemical conversion treatment. It is advantageous for the surface of an aluminum fin material to undergo chemical conversion treatment in terms of adhesiveness to a coating formed by hydrophilicity imparting treatment, corrosion resistance and so on. An example of the chemical conversion treatment is chromate treatment. Typical examples of chromate treatment include alkali salt-chromate methods (such as B.V. method, M.B.V. method, E.W. method, Alrock method and Pylumin method), a chromic acid method, a chromate method and a phosphoric acid-chromic acid method, and non-washing coat-type treatment with a composition predominantly composed of chromium chromate.

Examples of a thin aluminum plate usable for the fin material of a heat exchanger include pure aluminum plates compliant with JIS, such as 1100, 1050, 1200 and 1N30, Al—Cu alloy plates compliant with JIS, such as 2017 and 2014, Al—Mn alloy plates compliant with JIS, such as 3003 and 3004, Al—Mg alloy plates compliant with JIS, such as 5052 and 5083, and Al—Mg—Si alloy plates compliant with JIS, such as 6061. And these thin plates may have either sheeted or coiled shape.

Fin materials relating to the invention are preferably used in heat exchangers. The heat exchangers using fin materials relating to the invention can prevent water drops and dust from depositing between fins because the fin materials used have excellent hydrophile and antifouling properties and long persistence of these properties. These heat exchangers can be heat exchanges for use in a room cooler or room-air conditioner, an oil cooler for construction equipment, a car radiator, a capacitor and so on.

Of these uses, it is preferred that the heat exchangers with fin materials relating to the invention be used in air conditioners. Because the fin materials relating to the invention have excellent hydrophile and antifouling properties and long persistence of these properties, they can ameliorate the problem of air conditioners, namely degradation in cooling capabilities, and allow production of air conditioners of improved performance. These air conditioners may be used as any of room-air conditioners, packaged air conditioners and car air-conditioners.

In addition, known techniques (as disclosed in JP-A-2002-106882 and JP-A-2002-156135) can be applied to the heat exchangers and air conditioners according to the invention, and the invention has no particular restrictions as to techniques adopted.

### EXAMPLES

The invention will now be illustrated in more detail by reference to the following examples and comparative examples, but these examples should not be construed as limiting the scope of the invention in any way.

### Example 1

The following Solution A and Solution B were prepared independently. After these solutions were each stored at 24° C. for one month, a coating solution was prepared by adding Solution B to Solution A under stirring at 500 rpm with a magnetic stirrer and stirring the resultant mixture for 10 minutes.

Float sheet glass (2 mm in thickness), the commonest transparent sheet glass, was prepared and the surface of the sheet glass was made hydrophilic by UV/O₃ treatment of 10 minutes. Then, the coating solution was spin-coated on the sheet glass surface, and dried at 100° C. for 10 minutes, thereby forming a hydrophilic film having a dry coverage of 1.0 g/m². The waterdrop contact angle of the thus made hydrophilic member was found to be 2.1°, which proved that the hydrophilic member surface is very highly hydrophilic.

### <Solution A>

| | |
|---|---|
| 20 mass % Aqueous solution of colloidal silica | 180 g |
| dispersion (Snowtex C produced by Nissan | |
| Chemical Industries, Ltd.) | |
| Polymer (1) | 180 g |
| Tetramethoxysilane | 540 g |
| 5 mass % Aqueous solution of anionic | 10 g |
| surfactant illustrated below | |
| Purified water | 450 g |

Anionic Surfactant:

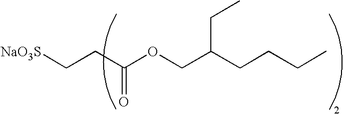

### <Solution B>

A mixture of 100 g of ethyl alcohol, 10 g of Ti(acac)₂ (produced by Aldrich) and 1 g of purified water was stirred for 10 minutes, and then admixed with 2 g of 1 mol/L hydrochloric acid, thereby preparing Solution B.

### (Synthesis of Polymer (1))

In a 500-ml three-necked flask, 57.5 g of acrylamide, 100 g of acrylamide-3-(ethoxysilyl)propyl and 280 g of 1-methoxy-2-propanol were put, and thereto 2.7 g of dimethyl 2,2′-azobis(2-methylpropionate) was added under a temperature condition of 80° C. in a stream of nitrogen. The resultant mixture was kept for 6 hours at that temperature with stirring, and then cooled to room temperature. The reaction mixture obtained was poured into 2 L of acetone to precipitate solid matter. The solid matter precipitated was filtered off, and washed with acetone to yield Polymer (1). The mass of Polymer (1) after drying was 60.2 g. The mass-average molecular weight of Polymer (1) was 8,800 as measured by GPC (upon the polyethylene oxide standard).

Hereafter, Polymers (2), (4) and (5) to be used in the following Examples, respectively, were synthesized in the same manner as mentioned above, and used for evaluations.

### (Synthesis of Polymer (3))

In a three-necked flask, 28 g of acrylamide, 3.7 g of 3-mercaptopropyltrimethoxysilane and 51.3 g of dimethylformamide were put and heated up to 65° C. in a stream of nitrogen. Thereto, 0.42 g of 2,2′-azobis(2,4-dimethylvaleronitrile) was added to initiate reaction. After stirring over a 6-hour period, the reaction mixture was cooled to room temperature, and then poured into 1.5 L of ethyl acetate to precipitate solid matter. The solid matter precipitated was filtered off, thoroughly washed with ethyl acetate, and then dried (yield: 18 g). By GPC measurement (upon polystyrene standard), it was ascertained that the solid matter was a polymer having mass-average molecular weight of 9,200. Further, it was ascertained that the viscosity of the polymer in a 5% aqueous solution state was 2.5 mPa·s and the functional-group density of hydrophilic groups in the polymer was 13.4 meq/g.

Hereafter, Polymer (6) to be used in one of the following Examples was synthesized in the same manner as mentioned above, and used for evaluations.

### Example 2

A hydrophilic member was made in the same manner as in Example 1, except that the acid catalyst was changed to 1 mol/L nitric acid (produced by Wako Pure Chemical Industries, Ltd.)

### Example 3

A hydrophilic member was made in the same manner as in Example 1, except that the metal alkoxide was changed to tetraethoxysilane (produced by Tokyo Chemical Industry Co., Ltd.).

### Example 4

A hydrophilic member was made in the same manner as in Example 1, except that the metal alkoxide was changed to tetrabutoxysilane (produced by Tokyo Chemical Industry Co., Ltd.).

### Example 5

A hydrophilic member was made in the same manner as in Example 1, except that the metal chelate or the metal salt was changed to Zircosol ZA-30 (an aqueous solution of ZrO(C₂H₃O₂)₂, produced by Daiichi Kigenso Kagaku Kogyo Co., Ltd.).

### Example 6

A hydrophilic member was made in the same manner as in Example 1, except that the metal chelate or the metal salt was changed to ZrOCl₂ (produced by Wako Pure Chemical Industries, Ltd.).

### Example 7

A hydrophilic member was made in the same manner as in Example 1, except that the metal chelate or the metal salt was changed to ZrO(NO₃)₂ (produced by Wako Pure Chemical Industries, Ltd.).

### Example 8

A hydrophilic member was made in the same manner as in Example 1, except that the metal chelate or the metal salt was changed to AlCl₃ (produced by Wako Pure Chemical Industries, Ltd.)

### Example 9

A hydrophilic member was made in the same manner as in Example 1, except that Polymer (1) was changed to Polymer (2) as illustrated below.

### Example 10

A hydrophilic member was made in the same manner as in Example 1, except that Polymer (1) was changed to Polymer (3) as illustrated below.

### Example 11

A hydrophilic member was made in the same manner as in Example 1, except that Polymer (1) was changed to Polymer (4) as illustrated below.

### Example 12

A hydrophilic member was made in the same manner as in Example 1, except that Polymer (1) was changed to Polymer (5) as illustrated below.

### Example 13

A hydrophilic member was made in the same manner as in Example 1, except that Polymer (1) was changed to Polymer (6) as illustrated below.

### Example 14

A hydrophilic member was made in the same manner as in Example 1, except that neither metal chelate nor metal salt was added and Polymer (1) was changed to Polymer (3).

### Example 15

A hydrophilic member was made in the same manner as in Example 1, except that no acid catalyst was added and Polymer (1) was changed to Polymer (3).

### Example 16

A hydrophilic member was made in the same manner as in Example 1, except that neither metal alkoxide nor colloidal silica dispersion was added.

### Example 17

A hydrophilic member was made in the same manner as in Example 1, except that Polymer (1) was changed to a 95:5 (mass ratio) mixture of Polymer (1) and Polymer (3).

### Example 18

A hydrophilic member was made in the same manner as in Example 1, except that Polymer (1) was changed to a 75:25 (mass ratio) mixture of Polymer (1) and Polymer (3).

### Example 19

A hydrophilic member was made in the same manner as in Example 1, except that Solution A was changed to the following.

### <Solution A>

| | |
|---|---|
| 20 mass % Aqueous solution of colloidal | 180 g |
| silica dispersion (Snowtex C) | |
| Polymer (1) | 540 g |
| Tetramethoxysilane | 540 g |
| 5 mass % Aqueous solution of anionic | 10 g |
| surfactant illustrated hereinbefore | |
| Purified water | 450 g |

### Example 20

A hydrophilic member was made in the same manner as in Example 16, except that Solution A was changed to the following.

### <Solution A>

| | |
|---|---|
| Polymer (1) | 400 g |
| 5 mass % Aqueous solution of anionic | 10 g |
| surfactant illustrated hereinbefore | |
| Purified water | 450 g |

### Example 21

A hydrophilic member was made in the same manner as in Example 1, except that the coating solution was prepared by mixing Solution B into Solution A under stirring at 100 rpm with a magnetic stirrer and further stirring the resultant mixture for 10 minutes.

### Example 22

A hydrophilic member was made in the same manner as in Example 16, except that the coating solution was prepared by mixing Solution B into Solution A under stirring at 100 rpm with a magnetic stirrer and further stirring the resultant mixture for 10 minutes.

### Example 23

A hydrophilic member was made in the same manner as in Example 1, except that the coating solution was prepared by mixing Solution B into Solution A under stirring at 50 rpm with a magnetic stirrer and further stirring the resultant mixture for 10 minutes.

### Example 24

A hydrophilic member was made in the same manner as in Example 16, except that the coating solution was prepared by mixing Solution B into Solution A under stirring at 50 rpm with a magnetic stirrer and further stirring the resultant mixture for 10 minutes.

### Example 25

A hydrophilic member was made in the same manner as in Example 1, except that the coating solution was prepared by adding Solution B to Solution A without stirring of Solution A by means of a magnetic stirrer and then carrying out a 10-minute stirring.

### Example 26

A hydrophilic member was made in the same manner as in Example 16, except that the coating solution was prepared by adding Solution B to Solution A without stirring of Solution A by means of a magnetic stirrer and then carrying out a 10-minute stirring.

### Comparative Example 1

A hydrophilic member was made in the same manner as in Example 1, except that the coating solution was changed to a coating solution for comparison prepared by mixing the following ingredients, adding thereto 1 mol/L hydrochloric acid in an amount of 2 g, stirring the resultant mixture for 10 minutes, and then leaving it at rest for one month at 24° C.

### <Ingredients for Use in Coating Solution for Comparison>

| | |
|---|---|
| Ethyl alcohol | 100 g |
| 20 mass % Aqueous solution of colloidal | 180 g |
| silica dispersion (Snowtex C) | |
| Polymer (3) | 180 g |
| Tetramethoxysilane | 540 g |
| 5 mass % Aqueous solution of anionic | 10 g |
| surfactant illustrated hereinbefore | |
| Purified water | 450 g |

### Comparative Example 2

A hydrophilic member was made in the same manner as in Comparative Example 1, except that the coating solution was changed to a coating solution for comparison prepared by adding 10 g of Ti(acac)₂ (produced by Aldrich) to the ingredients for use in coating solution for comparison without adding hydrochloric acid, stirring the resultant mixture for 10 minutes, and then leaving it at rest for one month at 24° C.

Structural formulae of Polymers (1) to (6) used in Examples 1 to 26 and Comparative Examples 1 and 2 are illustrated below.

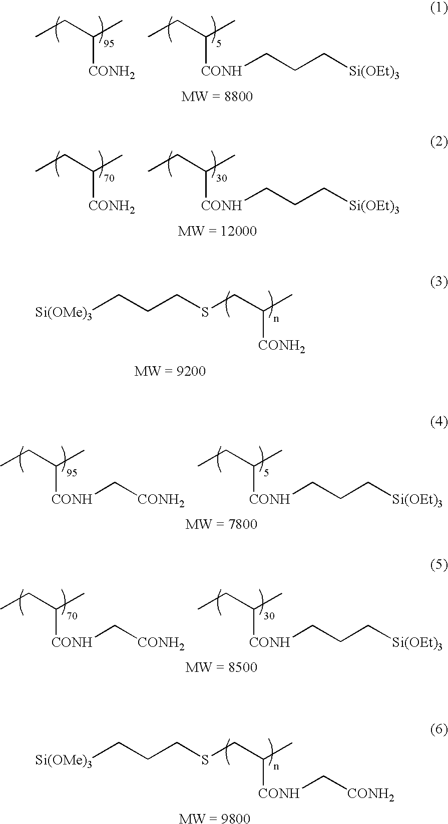

### (Evaluations)

The following evaluations were made on each of the foregoing hydrophilic members.

Hydrophilicity: In-air waterdrop contact angle measurements were carried out (by means of DropMaster 500, made by Kyowa Interface Science Co., Ltd.).
Pencil Hardness: Tests (using a pencil scratch hardness tester 553-M, made by Yasuda Seiki Seisakusho Ltd.) were conducted in conformance with JIS K 5400.
Water Resistance: Each hydrophilic member was immersed in distilled water, taken out of the distilled water after a lapse of 10 days, and then dried for 3 hours at room temperature. Thereafter, in-air waterdrop contact angle measurement was carried out on the thus treated member (by means of DropMaster 500, made by Kyowa Interface Science Co., Ltd.).
Solution Stability: With respect to Examples 1 to 26, Solution A and Solution B were mixed and stirred for 10 minutes. Then, stability evaluations were made on three portions of the resultant mixture after they were allowed to rest at 24° C. for ten minutes, one hour and five hours, respectively. With respect to Comparative Examples 1 and 2, evaluations were carried out on the coating solutions for comparison, respectively, after leaving the prepared coating solutions for comparison at rest for 10-minute at 24° C. Specifically, the evaluation of coating solution stability was made by average particle size based on the following criteria. And average particle size measurements were made by use of a dynamic light-scattering measuring instrument (ELS-800, made by Otsuka Electronics Co., Ltd.).

| | |
|---|---|
| Average particle size of less than 30 nm | Excellent |
| Average particle size ranging from less than 50 nm to 30 nm | Good |
| Average particle size ranging from less than 100 nm to 50 nm | Fair |
| Average particle size of 100 nm or above, or formation of | Failure |
| precipitate or occurrence of gelation | |

Coating Surface Condition: With respect to Examples 1 to 26, samples were made by using coating solutions prepared by mixing Solution A and Solution B, stirring the resultant mixture for 10 minutes, and then dividing it into portions and leaving them at rest for ten minutes, one hour and five hours, respectively, at 24° C. Evaluations were made on these samples in accordance with the following criteria. With respect to Comparative Examples 1 and 2, evaluations were carried out on samples made by use of the coating solutions for comparison, respectively, after leaving the prepared coating solutions for comparison at rest for 10-minute at 24° C. Specifically, the condition of each coating surface was evaluated by visible-light transmittance. The visible-light transmittance was determined in conformance with JIS R 3106 (by means of a Hitachi Spectrophotometer U3000).

| | |
|---|---|
| 85% or higher | Excellent |
| Between 80% and 85% | Good |
| Between 70% and 80% | Fair |
| 70% or lower | Failure |

Antifouling Property: In a 50-ml glass case, 0.2 g of palmitic acid was taken. This case was covered with a glass substrate coated with a hydrophilic layer in a condition that the hydrophilic layer side was exposed to palmitic acid gas, and subjected to 5 cycles of treatment made up of exposure to palmitic acid gas at 105° C. for 1 hour, washing with running water for 30 minutes and drying at 80° C. for 30 minutes. Contact angle measurement was made on the thus treated hydrophilic layer.

| | |
|---|---|
| 30° or below | Excellent |
| 31° to 40° | Good |
| 41° to 70° | Fair |
| 71° or above | Failure |

Viscosity: The viscosity of Solution A was measured at 20° C. with an E-type viscometer (RESOL, trade name made by TOKYO KEIKI INC.).

As measurement results, the viscosity of Solution A used in Examples 1 to 18 and 21 to 26 was found in a range of 10 to 20 mPa·s, and the viscosity of Solution A used in Examples 19 and 20 was found in a range of 50 to 60 mPa·s.

As to Comparative Examples, no viscosity measurement was made because neither of the coating solutions used was a two-liquid composition.

Results obtained are shown in Tables 1 to 3.

TABLE 1

| | | | | | Evaluations | | | | | |
|---|---|---|---|---|---|---|---|---|---|---|
| | | | | | | | | | Coating | |
| | | | | | | | | | Surface | |
| | | (B) | | | | | | Solution | Condition | |
| | | | | Metal | | | | Stability | 10-min. | |
| | | | | Chelate | Hydrophilicity | | Water | 10-min. rest | rest | Anti- |
| | (A) | Metal | | Or Metal | (Contact | Pencil | Resistance | 1-hr. rest | 1-hr. rest | fouling |
| | Polymer | Alkoxide | Acid | Salt | Angle) | Hardness | (degree) | 5-hr. rest | 5-hr. rest | Property |
| Example 1 | Polymer | Si(OMe)₄ | HCl | Ti(acac)₂ | 2.1 | 5H | 3.1 | Excellent | Excellent | Good |
| | (1) | | | | | | | Excellent | Excellent | |
| | | | | | | | | Excellent | Excellent | |
| Example 2 | Polymer | Si(OMe)₄ | HNO₃ | Ti(acac)₂ | 2.2 | 5H | 3.5 | Excellent | Excellent | Good |
| | (1) | | | | | | | Excellent | Excellent | |
| | | | | | | | | Excellent | Excellent | |
| Example 3 | Polymer | Si(OEt)₄ | HCl | Ti(acac)₂ | 3.2 | 5H | 3.3 | Excellent | Excellent | Good |
| | (1) | | | | | | | Excellent | Excellent | |
| | | | | | | | | Excellent | Excellent | |
| Example 4 | Polymer | Si(OBt)₄ | HCl | Ti(acac)₂ | 2.9 | 5H | 3.4 | Excellent | Excellent | Good |
| | (1) | | | | | | | Excellent | Excellent | |
| | | | | | | | | Excellent | Excellent | |
| Example 5 | Polymer | Si(OMe)₄ | HCl | Zircosol | 2.1 | 7H | 3.0 | Excellent | Excellent | Good |
| | (1) | | | ZA-30 | | | | Good | Good | |
| | | | | | | | | Good | Good | |
| Example 6 | Polymer | Si(OMe)₄ | HCl | ZrOCl₂ | 2.2 | 7H | 3.2 | Excellent | Excellent | Good |
| | (1) | | | | | | | Good | Good | |
| | | | | | | | | Good | Good | |
| Example 7 | Polymer | Si(OMe)₄ | HCl | ZrO(NO₃)₂ | 2.5 | 7H | 3.7 | Excellent | Excellent | Good |
| | (1) | | | | | | | Good | Good | |
| | | | | | | | | Good | Good | |
| Example 8 | Polymer | Si(OMe)₄ | HCl | AlCl₃ | 2.6 | 7H | 4.1 | Excellent | Excellent | Good |
| | (1) | | | | | | | Good | Good | |
| | | | | | | | | Fair | Fair | |
| Example 9 | Polymer | Si(OMe)₄ | HCl | Ti(acac)₂ | 2.4 | 4H | 3.5 | Excellent | Excellent | Good |
| | (2) | | | | | | | Excellent | Excellent | |
| | | | | | | | | Excellent | Excellent | |
| Example 10 | Polymer | Si(OMe)₄ | HCl | Ti(acac)₂ | 2.8 | 2H | 3.9 | Excellent | Excellent | Good |
| | (3) | | | | | | | Excellent | Excellent | |
| | | | | | | | | Excellent | Excellent | |
| Example 11 | Polymer | Si(OMe)₄ | HCl | Ti(acac)₂ | 2.0 | 6H | 3.4 | Excellent | Excellent | Good |
| | (4) | | | | | | | Excellent | Excellent | |
| | | | | | | | | Excellent | Excellent | |
| Example 12 | Polymer | Si(OMe)₄ | HCl | Ti(acac)₂ | 3.3 | 5H | 4.3 | Excellent | Excellent | Good |
| | (5) | | | | | | | Excellent | Excellent | |
| | | | | | | | | Excellent | Excellent | |
| Example 13 | Polymer | Si(OMe)₄ | HCl | Ti(acac)₂ | 3.4 | 3H | 4.3 | Excellent | Excellent | Good |
| | (6) | | | | | | | Excellent | Excellent | |
| | | | | | | | | Excellent | Excellent | |
| Example 14 | Polymer | Si(OMe)₄ | HCl | — | 3.2 | HB | 12.1 | Excellent | Excellent | Good |
| | (3) | | | | | | | Excellent | Excellent | |
| | | | | | | | | Excellent | Excellent | |
| Example 15 | Polymer | Si(OMe)₄ | — | Ti(acac)₂ | 3.1 | F | 11.2 | Excellent | Excellent | Good |
| | (3) | | | | | | | Excellent | Excellent | |
| | | | | | | | | Excellent | Excellent | |
| Example 16 | Polymer | — | HCl | Ti(acac)₂ | 5.1 | 4H | 5.5 | Excellent | Excellent | Good |
| | (1) | | | | | | | Excellent | Excellent | |
| | | | | | | | | Excellent | Excellent | |
| Example 17 | Mixture | — | HCl | Ti(acac)₂ | 11.2 | 2H | 11.5 | Excellent | Excellent | Excellent |
| | Of | | | | | | | Excellent | Excellent | |
| | Polymer | | | | | | | Excellent | Excellent | |
| | (1) and | | | | | | | | | |
| | Polymer | | | | | | | | | |
| | (3) | | | | | | | | | |
| Example 18 | Mixture | — | HCl | Ti(acac)₂ | 12.2 | 2H | 12.3 | Excellent | Excellent | Excellent |
| | Of | | | | | | | Excellent | Excellent | |
| | Polymer | | | | | | | Excellent | Excellent | |
| | (1) and | | | | | | | | | |
| | Polymer | | | | | | | | | |
| | (3) | | | | | | | | | |

TABLE 2

| | | | | | Evaluations | | | | | |
|---|---|---|---|---|---|---|---|---|---|---|
| | | | | | | | | | Coating | |
| | | (B) | | | | | | Solution | Surface | |
| | | | | Metal | | | | Stability | Condition | |
| | | | | Chelate | Hydrophilicity | | Water | 10-min. rest | 10-min. rest | Anti- |
| | (A) | Metal | | Or | (Contact | Pencil | Resistance | 1-hr. rest | 1-hr. rest | fouling |
| | Polymer | Alkoxide | Acid | Metal Salt | Angle) | Hardness | (degree) | 5-hr. rest | 5-hr. rest | Property |
| Example | Polymer | Si(OMe)₄ | HCl | Ti(acac)₂ | 2.1 | 5H | 3.2 | Good | Good | Good |
| 19 | (1) | | | | | | | Fair | Fair | |
| | | | | | | | | Fair | Fair | |
| Example | Polymer | — | HCl | Ti(acac)₂ | 6.4 | 4H | 6.8 | Good | Good | Good |
| 20 | (1) | | | | | | | Fair | Fair | |
| | | | | | | | | Fair | Fair | |
| Example | Polymer | Si(OMe)₄ | HCl | Ti(acac)₂ | 2.1 | 5H | 3.4 | Excellent | Excellent | Good |
| 21 | (1) | | | | | | | Excellent | Excellent | |
| | | | | | | | | Excellent | Excellent | |
| Example | Polymer | — | HCl | Ti(acac)₂ | 6.1 | 4H | 6.7 | Excellent | Excellent | Good |
| 22 | (1) | | | | | | | Excellent | Excellent | |
| | | | | | | | | Excellent | Excellent | |
| Example | Polymer | Si(OMe)₄ | HCl | Ti(acac)₂ | 2.2 | 5H | 3.3 | Excellent | Excellent | Good |
| 23 | (1) | | | | | | | Good | Good | |
| | | | | | | | | Fair | Fair | |
| Example | Polymer | — | HCl | Ti(acac)₂ | 6.5 | 4H | 6.6 | Excellent | Excellent | Good |
| 24 | (1) | | | | | | | Good | Good | |
| | | | | | | | | Fair | Fair | |
| Example | Polymer | Si(OMe)₄ | HCl | Ti(acac)₂ | 2.5 | 5H | 3.3 | Good | Good | Good |
| 25 | (1) | | | | | | | Fair | Fair | |
| | | | | | | | | Fair | Fair | |
| Example | Polymer | — | HCl | Ti(acac)₂ | 6.1 | 4H | 6.6 | Good | Good | Good |
| 26 | (1) | | | | | | | Fair | Fair | |
| | | | | | | | | Fair | Fair | |

TABLE 3

| | | | | | Evaluations | | | | | |
|---|---|---|---|---|---|---|---|---|---|---|
| | | (B) | | | | | | | Coating | |
| | | | | Metal | | | | Solution | Surface | |
| | | | | Chelate | | | | Stability | Condition | |
| | | | | Or | Hydrophilicity | | Water | 10-min. rest | 10-min. rest | Anti- |
| | (A) | Metal | | Metal | (Contact | Pencil | Resistance | 1-hr. rest | 1-hr. rest | fouling |
| | Polymer | Alkoxide | Acid | Salt | Angle) | Hardness | (degree) | 5-hr. rest | 5-hr. rest | Property |
| Compar. | Polymer | Si(OMe)₄ | HCl | — | 3.2 | 2B | 3.2 | Failure | Failure | Good |
| Example 1 | (3) | | | | | | | | | |
| Compar. | Polymer | Si(OMe)₄ | — | Ti(acac)₂ | 3.3 | B | 4.1 | Failure | Failure | Good |
| Example 2 | (3) | | | | | | | | | |

Even when the glass substrate was changed to an aluminum substrate, the resultant hydrophilic members were found to be on almost the same performance levels with their original hydrophilic members. The aluminum substrate used herein was an aluminum sheet (A1200, thickness: 0.1 mm) having undergone 10-minute immersion in an alkaline cleaning liquid (SemiClean A manufactured by Yokohama Oils & Fats Industry Co., Ltd., 5% aqueous solution) and thrice-repeated washing.

As is evident from Table 1, the hydrophilic members formed by use of the present two-liquid compositions delivered high temporal stability and had excellent scratch resistance, storage stability and surface conditions. In addition, it is apparent from Table 1 that higher scratch resistance was attained by using as catalyst an acid and a metal chelate or a metal salt in combination. Furthermore, it has been shown that especially high scratch resistance was achieved when Zr or Al was used as the metal of a metal chelate or a metal salt (Examples 5 to 8). On comparison between a group of Examples 1 to 18 and a group of Examples 19 and 20, it is understandable that both solution stability and coating surface condition were improved when Solution A has a viscosity of 40 mPa·s or below. On comparison between a group of Examples 1 to 18, 21 and 22 and a group of Examples of 23 to 26, it is also understandable that mixing Solution B into Solution A under stirring at the revolution speed of 100 rpm or above allowed further improvements in both solution stability and coating surface condition.

On the other hand, the hydrophilic members formed by use of the comparative coating compositions were bad in surface conditions because the coating compositions used were inferior in solution stability, namely on a level where practicality concern was caused. In addition, it is apparent (from Examples 17 and 18) that the combined use of the hydrophilic polymer having two or more hydrolyzable silyl groups per molecule and the hydrophilic polymer having one hydrolyzable silyl group per molecule provided a significant improvement in antifouling property.

According to the invention, the hydrophilic polymer having a hydrolyzable silyl group and the catalyst are mixed together at the time of use, so the present two-liquid composition does not cause the problem of forming aggregates and increasing its viscosity during the storage and it can deliver excellent temporal stability.

In addition, the present hydrophilic member can impart outstanding hydrophilicity to surfaces of various kinds of articles, and besides, it excels in scratch resistance, water resistance, storage stability and surface conditions.

The entire disclosure of each and every foreign patent application from which the benefit of foreign priority has been claimed in the present application is incorporated herein by reference, as if fully set forth.

What is claimed is:

1. A two-liquid composition, comprising:
(A) a first liquid composition that contains a hydrophilic polymer having a hydrolyzable silyl group; and
(B) a second liquid composition that contains a catalyst capable of accelerating reaction of the hydrolyzable silyl group.

2. The two-liquid composition according to claim 1,
wherein the first liquid composition (A) further contains a metal alkoxide compound.

3. The two-liquid composition according to claim 2,
wherein the metal alkoxide compound is a compound represented by formula (VI):
(R¹³)ₖ-Q-(OR¹⁴)₄₋ₖ (VI)
wherein R¹³ represents a hydrogen atom, an alkyl group or an aryl group;
R¹⁴ represents an alkyl group or an aryl group;
Q represents Si, Al, Ti or Zr; and
k represents an integer of 0 to 2.

4. The two-liquid composition according to claim 1,
wherein the catalyst contains an acid and a metal chelate or a metal salt.

5. The two-liquid composition according to claim 4,
wherein a metal contained in the metal chelate or the metal salt is at least one kind selected from the group consisting of Ti, Zr and Al.

6. The two-liquid composition according to claim 4,
wherein the acid is hydrochloric acid or nitric acid, and
the metal chelate or the metal salt is selected from the group consisting of aluminum ethylacetoacetate diisopropylate, aluminum tris(ethylacetoacetate), di(acetylacetonato)titanium complex salt, zirconium tris(ethylacetoacetate), ZrOCl₂.8H₂O, ZrO(NO₃)₂.4H₂O and AlCl₃.

7. The two-liquid composition according to claim 1,
wherein the hydrophilic polymer having a hydrolyzable silyl group is a polymer having at least one kind of structures represented by formulae (I) to (III): 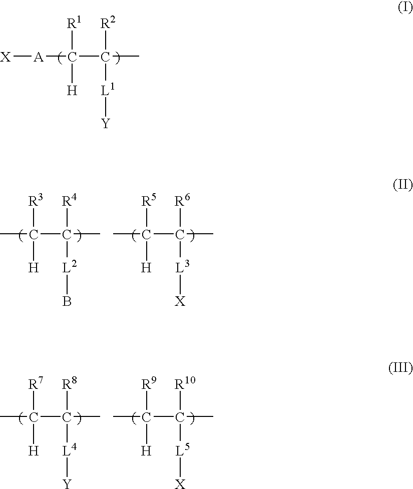
wherein R¹, R², R³, 4, R⁵, R⁶, R⁷, R⁸, R⁹ and R¹⁰ each represents a hydrogen atom or a hydrocarbon group independently;
X represents a hydrolyzable silyl group;
A, L¹, L², L³, L⁴ and L⁵ each represents a single bond or a linkage group independently;
Y represents —NHCOR¹¹, —CONH₂, —CON(R¹¹)₂, —COR¹¹, —OH, —CO₂M, —SO₃M, —PO₃M, —OPO₃M or —N(R¹¹)₃Z¹, wherein R¹¹ represents an alkyl group, an aryl group or an aralkyl group; M represents a hydrogen atom, an alkali metal, an alkaline earth metal or an onium; and Z¹ represents a halogen ion; and
B represents a group having a structure represented by formula (IV): 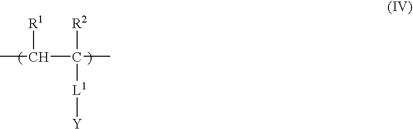
wherein R¹, R², L¹ and Y have the same meanings as in formula (I), respectively.

8. The two-liquid composition according to claim 7,
wherein the L⁵ in formula (III) represents a single bond or a linkage group having at least one structure selected from the group consisting of —CONH—, —NHCONH—, —OCONH—, —SO₂NH— and —SO₃—.

9. The two-liquid composition according to claim 1, which comprises the catalyst in the second liquid composition (B) in a proportion of 0.1 to 15 parts by mass with respect to 100 parts by mass of the hydrophilic polymer contained in the first liquid composition (A).

10. The two-liquid composition according to claim 1,
wherein the first liquid composition (A) has a viscosity of 100 mPa·s or below at 20° C.

11. A hydrophilic composition, obtained by adding the second liquid composition (B) of claim 1 into the first liquid composition (A) of claim 1 under stirring at a revolution speed of 100 rpm or above.

12. The two-liquid composition according to claim 7,
wherein the hydrophilic polymer having a hydrolyzable silyl group includes:
(I) a hydrophilic polymer having the structure represented by the formula (I); and
(II) a hydrophilic polymer having the structure represented by the formula (II) or (III) a hydrophilic polymer having the structure represented by the formula (II), and
a mass ratio of the hydrophilic polymer (I)/the hydrophilic polymer (II) or the hydrophilic polymer (I)/the hydrophilic polymer (i) ranges from 50/50 to 5/95.

13. A hydrophilic member, comprising:
a hydrophilic film formed by coating a substrate with the two-liquid composition according to claim 1 and then drying the composition.

14. A fin material, comprising:
a hydrophilic film formed by applying the two-liquid composition according to claim 1 and then drying the composition.

15. An aluminum fin material, comprising:
the fin material according to claim 14, the fin material being made from aluminum.

16. A heat exchanger, comprising:
the aluminum fin material according to claim 15.

17. An air conditioner, comprising:
the heat exchanger according to claim 16.
